(19) United States
(12) Patent Application Publication
(10) Pub. No.: US 2019/0354518 A1
(43) Pub. Date: Nov. 21, 2019

(54) CHAIN MESH NETWORK FOR DECENTRALIZED TRANSACTION SYSTEMS

(71) Applicant: Michael Zochowski, New York, NY (US)

(72) Inventor: Michael Zochowski, New York, NY (US)

(21) Appl. No.: 16/400,601

(22) Filed: May 1, 2019

Related U.S. Application Data
(60) Provisional application No. 62/665,113, filed on May 1, 2018.

(51) Int. Cl. G06F 16/23; G06F 16/901; G06Q 20/38

(52) U.S. Cl. CPC G06F 16/2379; G06Q 20/389; G06F 16/9024

(57) ABSTRACT

In some implementations, a distributed, trustless transaction network can be used to improve scalability of electronic transaction systems. The structure of the transaction network enables a transaction system to achieve high transaction throughout and low confirmation latency. In some instances, each account on the network has an individual chain that is tracks its transactions and allows independent transactions to be processed in parallel. A main settlement chain can provide universal synchronization of nodes as well as dynamic validator sets. Transactions can be validated and approved by a small number of delegates elected via a representative system, which reduces redundant operations while preserving safety. Consensus can be achieved using a delegated PBFT-based algorithm that is optimized for speed. Techniques described herein can be used to provide both accountable safety and plausible liveness through slashing conditions and other game theoretic incentives.

### CROSS-REFERENCE TO RELATED APPLICATION

This application claims the benefit of U.S. Provisional Application No. 62/665,113, filed May 1, 2018, which is incorporated by reference in its entirety.

### FIELD

The present specification relates generally to electronic transaction systems, and more specifically to distributed ledger technologies.

### BACKGROUND

A distributed ledger (or distributed ledger technologies) is a database that is consensually shared and synchronized across a peer-to-peer network that is spread across multiple sites, institutions, or geographies. A distributed ledger is decentralized, as there is often no centralized central administrator or centralized data storage. To ensure that transactions recorded on a distributed ledger are valid, distributed ledger technologies use a peer-to-peer network and consensus algorithms to ensure replication across nodes. One form of a distributed ledger design is a blockchain system, which can be either public or private.

### SUMMARY

Many blockchain consensus networks often struggle to maintain transaction performance in times of high activity. For example, many networks are often difficult to scale because a larger number of transactions over the network can cause network congestion, which can decrease transaction throughput and verification time.

In some implementations, an electronic transaction system can use a chain mesh network to improve scalability while maintaining decentralization and trustlessness. The chain mesh network can be built for applications that require cost-sensitive, efficient, intelligent, and secure transfers of economic value of different sizes (e.g., micro-transactions, industry-scale transactions). The chain mesh network described herein can be used to for a variety of transaction and simple data applications, including payments, internet-of-things (IoT), network coordination, digital identity, asset tokenization, securities settlement, and decentralized.

The chain mesh network can be a directed acyclic graph (DAG) that includes a dedicated chain of transactions for each account. The architecture of the chain mesh network can be used to enable parallel transaction processing rather than transaction processing in blocks, as used by many blockchain networks. Consensus can be achieved using a delegated Practical Byzantine Fault Tolerance (dPBFT) algorithm that provides liveness and safety as long as a portion of the nodes (e.g., two-thirds of nodes) by holdings are honest. In some instances, take slashing conditions can be combined with a robust reward structure align validator and overall network interests. A main settlement blockchain, referred herein as an “archive” can server as a ledger for finalized transactions, delegate elections, and native network governance.

The architecture and structure of the chain mesh network can provide various advantages relative to many blockchain networks that implement sequential block process. For example, the chain mesh network can provide practical scalability, a fully aligned incentive structure, and security in the presence of Byzantine faults. In particular, the chain mesh network allows transaction processing in parallel while maintaining universal consensus. A state sharding algorithm can be used to add a second dimension of parallelism that provides scaling in the number of validating nodes. In some implementations, the chain mesh network can be used to implement bounded smart contracts, which can enable sophisticated structures like payment channels, data capabilities, and interoperability with other virtual currency and/or digital asset networks. In this respect, the chain mesh network can provide transaction speeds that are comparable and/or an improvement over centralized transaction networks and decentralized transaction networks.

As discussed in detail below, the network generally achieves greater scalability than other crypto systems primarily through at least three features: (1) separation of leader selection, validator selection, and request validation, (2) decoupling of independent transactions, and (3) state sharding.

While many blockchain networks merge the processes of leader selection, validator selection, and request validation. In Bitcoin, for example, the leader and validator are one-in-the-same, and are determined by competitive proof-of-work mining, which also verifies transactions. Independent mining necessitates a block structure that bundles together transactions, as network latency as well as forking issues makes processing individual transactions infeasible. Proof-of-stake consensus algorithms typically achieve speed and energy efficiency gains by decoupling validator selection and request validation. By moving from a competitive, uncoordinated system to a coordinated system, blocks can be deterministically assigned to a validator according to simple rules rather than wasteful, arbitrary computation, and these blocks can be committed far faster.

Validator selection can be achieved via network rules that qualify a node as a validator, such as a minimum stake. However, this open, indirectly determined validator set results in anti-scaling with the number of validators, and the network may sacrifice some efficiency gains by allowing for a continuously dynamic set. Delegated consensus schemes directly determine locally fixed validator sets of relatively small size that can rapidly process transactions while also allowing for changes to the set over time and preserving safety conditions. Provided proper economic incentives, delegate nodes can be expected to become specialized for validation with sophisticated hardware. Any coordinated consensus system that requires x out of n validators to commit a transaction will naturally be limited by the x slowest honest validator, so encouraging specialization further improves capacity. The consensus algorithm discussed herein falls into this final category and leverages decades of established research on practical distributed systems.

Moreover, the hybrid base structure of the chain mesh network is unique and contributes to its scalability. The network uses a chain mesh structure that decouples independent transactions, which confers several advantages. For example, unrelated transactions can be processed in parallel rather than in batches. This can ensure that any issues that arise with conflicting transactions do not impact any independent transactions. Contrastingly, when blockchains identify a conflicting transaction, all unrelated transactions in the affected block as well as the block's descendants can potentially be reversed in a fork.

This first advantage has several additional implications. Forks can only be produced purposefully, and their impact is localized, meaning they can be resolved definitively and simply without wasting validator time and energy. Together with the choice of consensus algorithm, this means that clients do not need to wait for extended periods of time to be sure transactions are committed. Consistency between nodes on the global state is also ensured since there is only one unambiguous request that exist in each slot of any chain, whereas blockchain network nodes can have significantly different views of the global state depending on if they have seen the (correct) latest block. Blockchains can then place limits on both block time and block size, as pushing either past the limit increases both node inconsistency and fork probability, both of which lower overall network security and efficiency. Conversely, the network nodes can process unrelated transactions as quickly as possible given hardware and bandwidth constraints. Under this paradigm, requests are still processed in batches, so the network benefits from the gains from the ability to process in parallel and the obviation of block constraints (and the accompanying dangers that come along with violating them) without additional messaging overhead. Finally, the large number of transactions (as opposed to chunky blocks) can reduce reward variance to zero and removes the need for complicated leader elections that are practically challenging to implement.

Additionally, the network is capable of implementing a sharding technique that provides a second dimension of parallel processing. As discussed below, sharding can enable disjoint groups of accounts to independently process transactions. The network structure greatly simplifies sharding by natively assigning requests to a single account rather than a shared chain.

The structure of the chain can enable heavy pruning. To interact with the network, a node at a minimum needs the head of each account's chain, account summary data (including balance), and the last few blocks on an archive. Furthermore, system economics encourage users to close unused accounts to free up their deposits, which allows nodes to discard that account after all of its requests have been finalized. This means that the network can support very light autonomous nodes. This enables the system to a wide range of users that cannot support full nodes that are continuously online. Such light nodes can be used in peer-to-peer mobile apps, IoT devices, and point-of-sale applications. For security, the network foundation and other major stake- holders will maintain full histories of the network plus periodic, publicly available snapshots. This can enable light nodes to securely bootstrap up to the present.

In one particular implementation, the chain mesh network has a model tested of over 17,000 transactions/second with a confirmation latency of less than 2 seconds without sharding. In some other implementations that include sharding, the chain mesh network may allow a theoretical capacity in excess of 100,000 transactions/second under reasonable network assumptions. Deployment of sophisticated second layer solutions can be used to allow for further unbounded growth in capacity.

In one general aspect, a computer-implemented method can include the operations of: receiving, by one or more computers, a transaction request that includes at least a network identifier for an account associated with a blockchain network; identifying, by the one or more computers, a set of prior transaction requests that (i) were received by the one or more computers, and (ii) are associated with the account; generating, by the one or more computers, an account chain for the transaction request, wherein the account chain links (i) data representing the set of prior transaction requests and (ii) data representing the transaction request; and storing, by the one or more computers, the account chain and the network identifier.

One or more implementations can include the following optional features. For example, in some implementations, storing the account chain and the network identifier includes storing the account chain and the network identifier within an archive node of the blockchain network.

In some implementations, the blockchain network is a directed acyclic graph that is configured to store account chains for each account associated with the blockchain network.

In some implementations, the archive node includes multiple epochs that are each assigned to a time period in which transaction requests are received by the one or more computers.

In some implementations, the time period is twelve hours.

In some implementations, generating the account chain for the account includes the operations of: identifying a timestamp associated with the transaction request; determining that the timestamp falls within a particular time period assigned to a particular epoch from among the multiple epochs; and assigning the data representing the transaction request to the particular epoch.

In some implementations, the archive node includes multiple blocks that each correspond to one of the multiple epochs.

In some implementations, storing the account chain and the network identifier within the archive node of the blockchain network includes the operations of: assigning a respective epoch to each transaction request included in the account chain; and storing data representing corresponding transaction requests assigned to a particular epoch in a corresponding block from among the multiple blocks.

In some implementations, each of the multiple blocks provides a checkpoint that causes the one or more computers to execute state synchronization across nodes of the blockchain network.

Other versions include corresponding systems, and computer programs, configured to perform the actions of the methods encoded on computer storage devices.

The details of one or more implementations are set forth in the accompanying drawings and the description below. Other potential features and advantages will become apparent from the description, the drawings, and the claims.

Other implementations of these aspects include corresponding systems, apparatus and computer programs, configured to perform the actions of the methods, encoded on computer storage devices.

### BRIEF DESCRIPTION OF THE DRAWINGS

FIG. 1 is a conceptual diagram of an example of a chain mesh network.

FIG. 2 is a conceptual diagram of an example of an archive for a chain mesh network.

FIG. 3 is a conceptual diagram of an example of network participants in a chain mesh network.

FIG. 4 is a conceptual diagram of examples of messages types sent during consensus algorithm of a chain mesh network.

FIG. 5 is a conceptual diagram of an example of a bootstrapping sub-system.

FIG. 6 is a state diagram that illustrates an example of a bootstrapping process.

FIG. 7 is a conceptual diagram that illustrates a sequence for bootstrap initialization and the start of bulk pull requests.

FIG. 8 is a conceptual diagram that illustrates how a bootstrapping process operates when it is up and running.

FIG. 9 is a conceptual diagram that illustrates an example of a consensus architecture.

FIG. 10 is a sequence diagram that illustrates an example of a consensus sequence.

FIG. 11 is a sequence diagram that illustrates an example of a fallback consensus sequence.

FIG. 12 is a sequence diagram that illustrates an example of a consensus sequence using a secondary waitlist.

FIGS. 13A-D are sequence diagrams that illustrate an example of a token issuance process.

FIG. 14 is a flowchart that illustrates an example of a process for processing a blockchain-based transaction using a chain mesh network.

FIG. 15 is a schematic diagram that illustrates an example of a computer system that may be applied to any of the computer-implemented methods and other techniques described herein.

FIG. 16 is a schematic diagram that illustrates an example of an environment that can be used to execute implementations of the computer-implemented methods and other techniques described herein.

In the drawings, like reference numbers represent corresponding parts throughout.

### DETAILED DESCRIPTION

In general, one innovative aspect described throughout this specification includes a scalable chain mesh network that can be used with an electronic transaction system to provide high transaction throughput. The chain mesh network can have characteristics that provide various advantages compared to blockchain networks. As examples, the chain mesh network can maintain transaction security, increase transaction throughput, provide high accessibility, provide scalability to accommodate an arbitrary number of users without performance degradation, can be persistent and resistant to censorship or single points of failure, and perform validation using a minimal resource (e.g., computational power, energy) to meet objectives to minimize economic deadweight.

### A. Network Objectives and Assumptions

a. Network Objectives

The chain mesh network can be deterministic replicated state machine across a set of nodes, N, that transitions from state to state via operations requested by clients. The chain mesh network has certain fault tolerance properties to provide safety and liveness in processing transactions. For example, the network is linearizable (i.e., the network behaves like a trusted centralized service that execute operations atomically). As another example, the network provides replies to client requests even if transaction failures occur (i.e., the network does not halt despite individual failures).

A system implementing the chain mesh network can use a Byzantine failure model, meaning faulty processes may deviate arbitrarily from a specified protocol, such as by sending contradictory messages or failing to respond. Since the network is capable of operating on systems with different infrastructures with their own faults, such as the Internet, asynchronicity is preferred. That is, since it is not possible to know a priori if an unresponsive process is Byzantine or merely delayed, the network should accommodate all reasonable response times to a particular request without breaking or delaying independent requests.

In some instances, the chain mesh network is designed to err on the side of safety rather than absolute liveness since the CAP Theorem states that it may be impossible for a distributed system with potentially unreliable nodes to guarantee both safety and liveness. To accomplish this, the network can rely on some weak synchronicity assumptions to give plausible liveness. In the event of an extended network partition, a child network with sufficient support can continue to function properly.

To process requests, the network uses a consensus protocol that satisfies the certain properties. As one example of a property, every correct process agrees on the same value (safety property). Other example of a property is that if all processes propose the same value v, then all correct processes decide v (non-triviality property). As another example, every correct process decides at most one value, and if it decides some value v, then v must have been proposed by some process (safety property). As yet another example, every correct process decides some value (liveness property).

We must also provision for clients entering the network, either for the first time or after an extended period offline.

The chain mesh network can be structured so that nodes can rely on a weak subjectivity assumption similar to that in some proof-of-stake proposals. Specifically, a new node can independently verify the system state at time t given (i) a protocol definition, (ii) the set of all operations and validation messages, and (iii) the system state at time tₛ such that t−tₛ<F for some constant finalization time F. Under this paradigm, nodes reject any proposed changes to any historical state with age greater than F. In fact, chain mesh network can provide much stronger finalization guarantees through its consensus algorithm, but it also locks in validator stakes for at least F time to ensure economic finality in the interim. System snapshots can be widely disseminated by potentially trustworthy sources, such as large companies or nodes in social networks, that are jointly trustworthy with high confidence, which will allow new nodes to bootstrap to the present.

The chain mesh network described herein can also include a native governance mechanism that enables stake holders to modify system rules and parameters as needed while maintaining integrity. As discussed in detail below, the governance mechanism can allow for seamless upgrades of many network functions and avoiding the messy governance disputes that have plagued many cryptocurrencies and/or blockchain networks.

b. Assumptions

The chain mesh network generally makes certain assumptions. For example, one assumption is that fewer than one third of (weighted) validators are Byzantine. In this example, the consensus algorithm of the chain mesh network can require a total of n≥3f+1 nodes in the presence of f faults. While there may be algorithms that require only n≥2f+1 nodes, these algorithms also require strict synchronicity and are comparatively more complex. As discussed herein, the consensus algorithm of the chain mesh network requires only partial synchronicity, and this Byzantine assumption is a tight bound for the partially synchronous context. It is also assumed that Byzantine failures are independent but allow that faulty nodes can be coordinated by an attacker.

Additionally, at least two thirds of nodes' system times are practically in sync, meaning that the maximum difference is substantially less than some large time constant L_{E}, the length of each distinct validation period. Furthermore, the maximal delay of messages between validating nodes by L_{E} are bounded. However, asynchronous behavior of nodes within each validation period can be allowed. These assumptions can be slightly stronger than the standard PBFT synchronicity assumption.

It is also assumed that the connectivity of the nodes is non-pathological. For instance, the network can be relatively well connected such that there is some path that exists between any two honest validators. This feature, together with partial synchronicity, ensures that messages between honest nodes will be delivered in bounded time.

Moreover, it is assumed that an attacker cannot delay honest nodes indefinitely. Additionally, an attacker is assumed to be computationally bounded, such that standard cryptographic assumptions hold. The chain mesh network may or may not use quantum resistant cryptography, but in some instances, is designed to accommodate arbitrary cryptographic schemes if the need arises.

### B. System Overview

The chain mesh network achieves consensus using a delegated Proof-of-Stake (PoS) algorithm with dynamic weighting based on Practical Byzantine Fault Tolerance (PBFT). The network is a replicated state machine including a set of replicas called nodes, N, that manage a distributed database of accounts, A. These two sets are distinct, and a node can correspond to a single, multiple, or no accounts. Accounts have a variety of associated data, including the balance of the native value token, Ł. Using the partial synchronicity assumption, real time can be divided into distinct, successive time periods called epochs, E, each with fixed length L_{E} (on the order of 12 hours), that have a definitive, agreed-upon ordering by the nodes.

Nodes interact via messages m containing public-key signatures and message digests H(m), where H is a collision-resistant hash function. A message is denoted and m and signed by node i as m_{αi}.

Changes to account data, such as sending Ł, are accomplished via authenticated messages called requests (transactions) sent by that account. Accounts appoint agents called representatives, R⊆A, that are trusted to run connected nodes and act on their behalf. Requests are received by, validated, and committed to the database by a set of delegates, D⊆R, that are elected by the representatives. This relationship is expressed as a one-to-many mapping R: A→R. An account can act as its own agent by designating itself as its own representative. The voting power of each representative can be determined by a function of its account balance and the total account balance it represents. Both representatives and delegates are paid for successfully processing transactions and are penalized for inactivity or malicious behavior. We designate each state of the system, including all account data and messages, as a configuration.

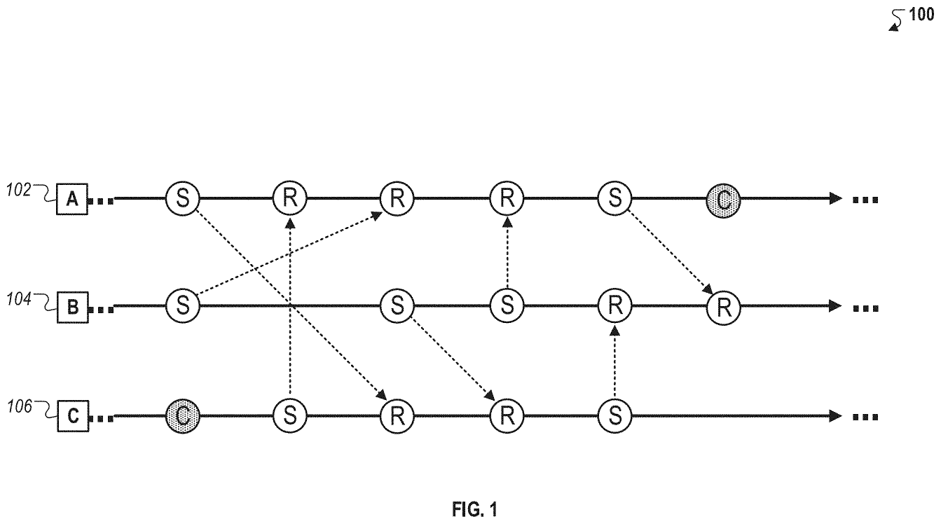

FIG. 1 is a conceptual diagram of an example of a chain mesh network 100. The network 100 is a network of nodes that track a set of accounts, each with a balance of the native network token. Unlike the UTXO model used by many cryptocurrencies that tracks each individual transaction separately, this model tracks the running balance for each account. This type of structure is similar to a bank database, which records balance at the beginning of the month and the transactions for that month. For example, transactions that occurred two years ago are largely irrelevant as long as the account holds knows the current balance.

Each account is identified by a public key, and the corresponding private key can be used to approve transactions (referred to as “requests”) from that account. Instead of batching together requests into blocks and recording them in a blockchain, the nodes of the network 100 record individual chains of requests for each account. In the example shown in FIG. 1, the network 100 includes three account chains 102, 104, 106 that are each associated with accounts “A,” “B,” and “C,” respectively. Transactions of each account are linked together in a corresponding account chain and are represented as “requests.” In the figure, request transactions are denoted as “R,” send transactions are denoted as “S,” and change representative requests are denoted as “C.” More specific descriptions of each of these types of transactions is provided below.

Since transactions move money between multiple accounts (e.g., accounts A, B, C) (every send has at least one recipient), transactions link together different account chains. For example, in FIG. 1, account chains 102 and 104 are linked together by a send transaction originating from account B and a request transaction to account A as the destination account. Send requests and receive requests are separate, which allows a receiving account (e.g., account A) to choose when to add an incoming transaction to its chain. If each request is viewed as a vertex and each reference to a request as an edge (each request refers to the previous request in the account chain, and each receive request refers to the corresponding send on another account chain), then the resulting structure is what is referred to as a directed acyclic graph (DAG). This means that there is at least one total ordering of all transactions, which is a key security property, and the structure the chain mesh.

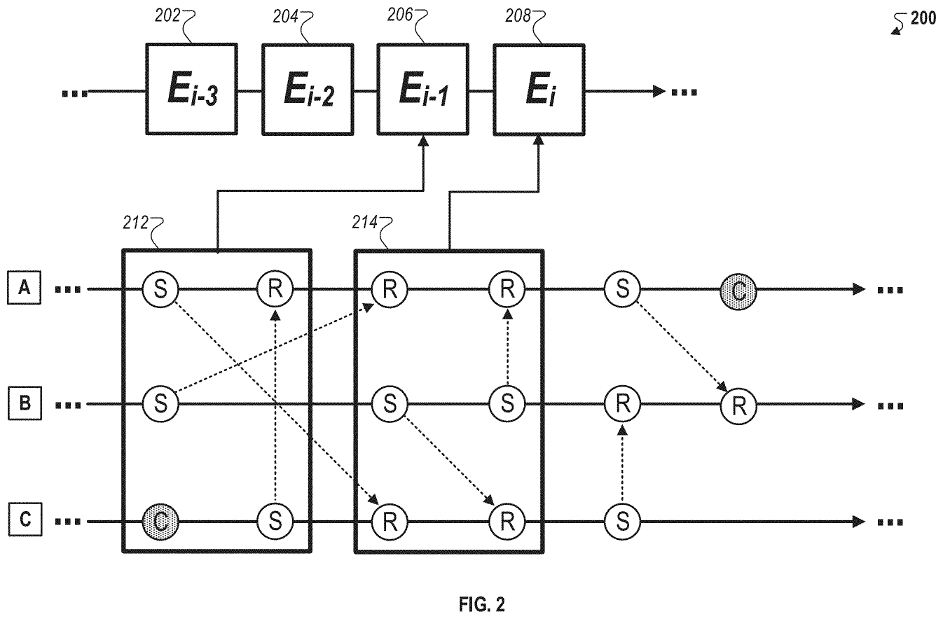

FIG. 2 is a conceptual diagram of an example of an archive for the network 100 depicted in FIG. 1. The network 100 records all transactions that occurred in a set period of time in a blockchain referred to as an “archive.” The archive can also contain results of votes and other system events that are discussed in detail below. The period of time covered by a single archive block is referred to as an “epoch.” Each epoch can be very long (e.g., on the order of 12 hours), so limits imposed by the blockchain structure do not interfere with network speed. Rather than handling ongoing transactions (which can be done by the chain mesh), the archive instead serves as a periodic checkpoint that summarizes what has changed in the system. The archive confers many benefits, including forcing the network nodes to synchronize, helping new nodes bootstrap to the present state, and enabling a decentralized governance system.

In the example depicted in FIG. 2, four consecutive epochs 202, 204, and 206, and 208 of the archive are depicted. As discussed above, each epoch represents transaction blocks occurring over a period of time. In the figure, epoch 206 represents a transaction block 212, which includes three transactions (e.g., a send request sent from account A to account C, a send request set from account B to account A, and a receive account received by the account A from account C). Additionally, the transaction block 214 identifies four transactions four transactions (e.g., a receive request received by account A from account B, a receive request received by account C from account A, a send request sent by account B to account A, and a send request sent by account B to account C).

This hybrid architecture collectively depicted in FIGS. 1 and 2, when implemented in parallel, can capture the best of both the DAG and blockchain structures. DAGs (like the chain mesh structure depicted in FIG. 1) are best for rapid, parallel transaction processing and have fewer forking problems than blockchain, while blockchains (like the archive depicted in FIG. 2) are good at recording universal state changes and governance modifications at a lower frequency.

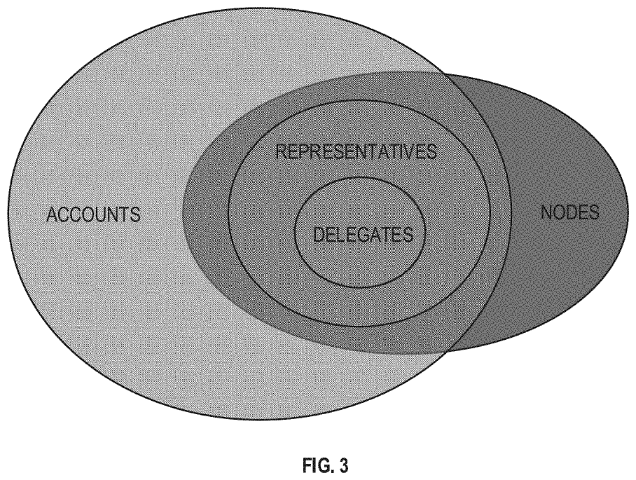

FIG. 3 is a conceptual diagram of an example of network participants in the network 100 depicted in FIG. 1. The participants collectively form a consensus scheme that is discussed in detail below. The consensus scheme consists of two components: first, a mechanism for selecting a set of validators; and second, a mechanism for those validators to come to agreement on changes to the account database. The consensus scheme selects validators via a delegated proof-of-stake mechanism, and those validators reach consensus using a PBFT-based algorithm discussed in detail below.

A proof-of-stake can be an alternative to proof-of-work (mining) where power in the system is derived from buying and holding network tokens (a stake) rather than from computer power. As discussed above, proof-of-work can be used to bootstrap cryptocurrencies from zero value. Proof-of-stake would not have been a viable hurdle to becoming a validator since there was no economic cost to buying something with zero value.

However, now that cryptocurrencies have substantial value, using proof-of-stake to establish validator identity is far better than proof-of-work for two primary reasons. First, it is significantly more energy efficient since validators do not need to mine. Second, it requires coordination between validators, which allows transactions to be processed much faster. There typically is one major drawback in standard implementations of proof-of-stake: since a majority of validators need to see each transaction (a basic requirement for BFT), allowing anyone who stakes tokens to become a validator will result in a large number of validators, which slows the system down. This is effectively anti-scaling in the number of validators, while proof-of-work has constant scaling (mining difficulty is adjusted to ensure average block time is constant).

To solve this issue, the network 100 has a delegated validation system with several levels. The idea is that stakeholders at each level elect a smaller number of agents to represent them, which minimizes the required number of messages to run the system.

The bottom level is the set of accounts, the majority of which are typically offline and not paying attention to the ongoing validation. Accounts designate other accounts that they expect to be online and trust as their representatives, which can be changed at any time. These representatives vote on governance proposals and elect the validators, called delegates, that run the actual consensus algorithm to process transactions. Since consensus is an expensive process that requires many messages, the number of delegates is fixed at small number (typically less than 100). This means that transaction processing time has constant scaling in the number of nodes.

The network 100 provides the ability to process non-dependent transactions in parallel while maintaining the safety and liveness properties of PBFT. However, since transactions are committed at specific real times and require signed prior references, there is a definitive ordering of configurations. Nodes can behave deterministically, and the network can initiate an initial configuration shared by all nodes. Safety is guaranteed by ensuring that all non-faulty nodes agree on a total order of execution of messages and their deterministic results despite failures.

The capabilities of the network 100 can be enabled by a data structure scheme in which each account has a totally ordered set of committed requests that form a chain that can be somewhat analogous to an individualized blockchain. Only an individual account is able to request changes to their account (except in the case of provable misbehavior). Since the system processes requests individually (rather than in blocks), this means that, unlike traditional blockchains, chain forks and reorganizations can only occur when an account intentionally double spends. Via related requests, these blockchains form dependency relationships that, as a whole, reflect the overall system.

The chain mesh with in the network 100 is constituted as a set of accounts 102, 104 plus the dependency graph. A main settlement chain, which is called an archive, consists of blocks for each epoch (shown in FIG. 2). These blocks contain a summary of all requests that occurred in that epoch, election results for delegates for a subsequent epoch, voting results for governance changes in future epochs, and other global information.

The archive generally serves at least four primary purposes: (1) its blocks serve as checkpoints that force state synchronization across nodes; (2) it enables validator sets to change while the system runs fixed validator consensus algorithm; (3) it facilitates decentralized governance; and (4) it provides a consolidated history for bootstrapping. This hybrid model ensures universal consensus while also allowing account requests to be processed individually and in parallel. The result is that the chain mesh network has the security of a traditional blockchain but can also scale transaction throughput based on validator hardware limits.

The inclusion of the archive allows for universal finality and a synchronization mechanism. The Byzantine-fault-tolerant consensus protocol and incentive structure can provide explicit security and game theoretic guarantees lacking in other DAG-based networks. As a result, the chain mesh structure is capable of providing the scalability, throughput, and latency of DAG-based networks while providing the security of many blockchain networks.

A breakdown of account and node types and their various functionalities and responsibilities are discussed below and illustrated in Table 1.

TABLE 1
Roles and functions of chain mesh network participants.
Network Participant Roles

| Accounts | Passive Accounts | | Create requests |
|---|---|---|---|
| | | | Open/close account |
| | | | Send/receive tokens |
| | | | Change representative |
| | Representatives | Non-Delegate | Maintain global |
| | | Representatives | state Elect |
| | | | delegates |
| | | | Validate delegate commitments |
| | | | Approve archive |
| | | | blocks Recall |
| | | | delegates |
| | | | Propose and vote on |
| | | | governance changes Enforce |
| | | | slashing conditions |
| | | Delegates | Validate requests |
| | | | Propose archive |
| | | | blocks Recall |
| | | | delegates |

| | |
|---|---|
| Non-Account Nodes | Maintain global state |
| | Police representative and delegate actions |
| | Provide network access to passive accounts |
| | and light clients |

a. Accounts

Accounts aᵢ ∈ A are defined by the following type of values:

Address (i): The public key component of a digital sig- nature key-pair, used to identify the account. The private key component is kept secret and is used to sign requests and other messages approved by the account. Only one address may exist per account.

Balance (bᵢ): the account's native token balance, Ł Representative (rᵢ): the account's designated voting representative, which can be the account itself.

Account Chain (cᵢ): the account's historical chain of transactions, beginning with an open request.

Deposit (dᵢ): the deposit required to open the account, with the required amount set based on the epoch.

Each account can issue requests that modify the account state provided that they are cryptographically signed and valid. Each request can be appended to the account chain in the order that the account chooses, subject to protocol verification and consensus. Because the network 100 does not use an unspent transaction output (UTXO) structure like Bitcoin, each account chain can be extensively pruned due to the existence of the balance field and a periodic checkpoint mechanism (as discussed below).

The account representative, which votes on behalf of the account's balance, is determined by the mapping ri=R(aᵢ). An account can change its representative at any time via a request, but voting choices for a particular epoch are static based on the representative mapping from the end of the previous epoch.

A small deposit (specified by the network parameters set in the current epoch) is required to open an account. The deposit reflects the real cost of storing the account data across the network (on the order of $1). Along with a modest proof-of-work requirement for account requests and variable transaction fees, this is one of the three primary deterrents of spam attacks. The deposit also incentivizes closing unused accounts, which enables further pruning.

b. Requests

Different types of requests can be created to interact with the network 100. The header of each request can include an account field containing an address (e.g., public key) of the account, and a head field containing the hash of the previous request of the account chain.

Examples of requests include “Open Account,” “Close Account,” “Send Transaction,” “Receive Transaction,” and “Change Representative.” Each type of request is discussed below.

i. Open Account

An open account request can be issued to create an account on the network 100. The open account request is the first (or “genesis”) block of every account chain and is created when tokens are initially sent to the account. The source field contains a hash of the incoming send request. The representative field contains the address of the account's designated voting representative (initially the account itself by default).

An example of an open account request is provided below:

```
request: open {
      account: _{—}
      head: null
      source: _{—}
      representative: _{—}
}
```

To issue an open account request, a user first generates a virtual account (e.g., a digital signature key-pair) that exists locally on the user's node. The user then issues a send transaction request to the virtual account from another account (e.g., an account controlled by a user, a friend, or an exchange). An open account request can be viewed as a variation of a receive transaction request, as the request instantiates a new account chain for the account while simultaneously claiming the incoming unsettled tokens in the settlement pool. In some instances, the initial balance should be sufficient to cover the minimum account deposit required by the current epoch in order for the open account request to be validated by the network.

The transaction fee field in the open account request can have a value greater than 0 to the extent that the received amount is greater than the minimum deposit. For instance, if the amount in the initial send transaction request is insufficient, then another send transaction request that satisfies the requirements can be issued, and the initial send transaction request can be claimed later via a normal receive transaction request. The deposit can then be locked for the lifetime of the account.

ii. Close Account

A close account request can be a modified send transaction request that simultaneously releases the deposit in the account. The send transaction request can send the entire account balance, including the deposit, and results in the deletion of the account from the network. The account may be reopened later, but it would initialize with a new account chain and metadata. An example of a close account request is shown below.

```
request:close {
      account: _{—}
      head: _{—}
      destination: _{—}
}
```

iii. Send Transaction

A send transaction request can be issued to send tokens to another account. The destination field contains the addresses of one or more recipients. The balance field contains the amount of tokens to be sent to each recipient. Once the request is confirmed by the network, the sum of the amounts is deducted (e.g., immediately and irreversibly) from the balance of the account. Before the amount is accepted by the destination account with a receive transaction request (as discussed below), the unsettled tokens in transit are tracked in a settlement pool that is analogous to a mem pool. An example of a send transaction request is provided below.

```
request:send {
      account : _{—}
      head: _{—}
      destination : _{—}
      balance : _{—}
}
```

A send transaction request can be used to send tokens to multiple sources and can also include a field for a user-defined transaction fee paid to validators (as discussed below). In some implementations, a Pay to Script Hash (P2SH) functionality and data fields can be incorporated to enable rich, intelligent transactions. In some instances, a send transaction request may not spend amounts stored in the account deposit.

iv. Receive Transaction

A destination account can issue a receive transaction request to claim tokens sent by a send transaction request from an originating account. Each receive transaction request can present proof that the network 100 has validated and committed the corresponding send transaction request, which practically takes the form of validator signatures. The receive transaction request can be added to the destination account chain independently from the send transaction request. As discussed above, unsettled tokens from “unconfirmed” send transaction requests can remain in the settlement pool. An example of a receive transaction request is provided below.

```
request:receive {
      account: _{—}
      head: _{—}
      source: _{—}
}
```

The network 100 derives several advantages from processing each receive transaction request independently from its associated send transaction request. For example, each account can control the ordering of its account chain. This can be used to prevent disputed incoming send transaction requests from creating any blocking conditions. Otherwise, the destination account for the disputed send transaction request would be unable to issue valid new requests since the previous request in the account chain (the head) is indeterminate.

As another example, processing each receive transaction request independently from its associated send transaction request allows for asynchronicity in the network 100 when processing different unsettled send transaction requests while simultaneously ensuring that all nodes by definition agree with the settled balance of the account. In yet another example, the independent processing of the receive transaction and send transaction request enables aggressive pruning within the network 100 since lightweight nodes can keep track of only a running settled balance for accounts rather than the full account chain.

v. Change Representative

A change representative request can be used to update a designated voting representative of an account. The change representative request can be issued at any time but will only go into effect in subsequent epochs. The delay ensures that the network 100 has a complete, constant view of the set of representatives and their voting power at all times during each epoch. After the change representative request is committed to the account chain, the voting power of the account is transferred from the old representative to the new representative. An example of a change representative request is below.

```
request: change {
      account: _{—}
      head: _{—}
      representative: _{—}
}
```

vi. Anatomy of a Request:

As discussed above, each request includes a set of fields, such as account, head, or representative. Each request can also have certain requirements. For example, the requests can have a proof-of-work (PoW) solution to prevent spam. The PoW difficulty can be specified in the governance conditions of the current epoch and can also vary by request type, with requests that require more network resources (e.g., open account requests and sent transaction requests with a large number of outputs) having a higher difficulty.

Each transaction can be associated with a transaction fee that is paid to the network 100 for confirming each request, which then rewards network participation and prevents spam. Each transaction can also be associated with a hash of a recent epoch block that ties the request to a specific history and acts as a defense against short- and medium-range attacks (an application of Transactions as Proof-of-Stake (TaPoS)). A timestamp (within an acceptable of network time) is also specified within each request to helps define a global ordering of requests (along with the head field). Additionally, the requests include a signature confirming that the request was sent by the account (the holder of the private-key).

c. Representatives

Representatives rᵢ ∈ R are responsible for electing delegates to validate requests, voting on proposed governance changes, and adding blocks to the archive. To qualify as a representative, an account must post a moderate deposit beyond the minimum amount for normal accounts, and choose themselves as the representative. Representative deposits and balances can be subject to slashing conditions if the representative fails to follow certain network rules as discussed below. Representative balances (including the deposit) can be locked from when they enter the representative pool until F+1 epochs after they withdraw from the representative pool, where F is the number of epochs where economic finality is provided.

Each representative can have a set of constituent accounts, Cᵢ={j|R(aⱼ)=rᵢ}. The voting power of the representative is determined by the following function:

V(rᵢ)=bᵣ_{ᵢ}+γ·Σₐ_{ⱼ}_{∈C}_{ᵢ}_{;j≠i}bₐ_{ⱼ} (1)

where λ ∈ [0, 1] is a scalar that penalizes represented balances since they are not directly staked (on the order of 1/4). This disincentivizes representatives from holding most of their balance in other accounts that appoint a single account as representative to avoid slashing conditions.

By the Byzantine assumption, |R|>3f_{R}+1, where f_{R} is the number of Byzantine agents (weighted by voting power). In practice, accounts are expected to move balances to honest representatives before the threshold is breached.

Representatives receive a portion of transaction fees proportional to their weights if they are connected to the network 100, and are penalized if they are not online to vote. This incentivizes representatives to run reliable and honest nodes.

To ensure representative accountability, accounts that appoint poor representatives that either continuously fail to vote or violate network rules are subject to small penalties. Furthermore, since representatives receive fees proportional to their constituent balance, they may be willing to share some of those fees with accounts to attract additional balances. This structure incentivizes accounts to maintain quality representatives, prevents shielding funds from slashing, and encourages a large portion of network value to be actively securing the network while allowing most accounts to remain offline.

d. Delegates

Delegates dᵢ ∈ D validate and commit requests on each account chain and propose blocks to the archive. Delegates are elected for terms of a fixed number epochs, although any one delegate can serve any number of consecutive terms. Delegates are weighted by their number of votes.

If delegates are not properly fulfilling their duties, either by going offline or acting maliciously, they can be recalled by more than two thirds of either delegates or representatives. A successful recall closes the current epoch and starts the next one with its delegates. Multiple recalls may be necessary to flush out all bad delegates. All votes are subject to slashing conditions.

By the Byzantine assumption, the number of Byzantine delegates is |D|>3f_{D}+1, where f_{D} is the number of Byzantine agents. This is significantly weaker than the representative Byzantine assumption due to finite epoch length and recalls. Representatives directly validate delegate activity, so under most circumstances delegates can only threaten liveness but not safety.

Like normal representatives, delegate stakes are locked from when they are elected as delegates until F+1 epochs from the last period the account acted as a delegate to prevent any history attacks before all nodes recognize finality.

### C. Consensus Protocol

Consensus within the network 100 can be achieved using a consensus protocol that is a delegated version of the PBFT algorithm. Voting power can be determined by a Proof-of-Stake (POS) class function, which prevents Sybil attacks and allows nodes to enter and leave the network 100. In some instances, the consensus algorithm can be represented as modified PBFT that is tailored to unique structure of the network 100.

a. Detailed Protocol

The consensus algorithm discussed herein can generally be a mechanism for state machine replication in the presence of Byzantine faults. The algorithm provides both liveliness and safety, provided that there are n≥3f+1 validation nodes (weighted by some weight function) with f faulty nodes. Specifically, the consensus algorithm is a PBFT-derived algorithm that allows for large, dynamic node sets to achieve consensus on transactions, votes, and epoch blocks. Each instance of PBFT requires a single leader called a primary to propose transactions and manage feedback from the other validators. Primary selection for each network operation is described in detail below.

PBFT typically requires O(n²) messages between nodes and O(n) signature size, but use of EC-Schnorr signatures reduces message complexity to O(n) and signature complexity and verification to O(1). The algorithm can use digital signatures rather than the MAC scheme used by a standard PBFT. Nodes verify consensus via multi-signatures. However, since EC-Schnorr multi-signatures are constant size (rather than a concatenation of single signatures), and consensus requires signatures from more than 2/3 n nodes, it may be necessary to keep track of which node has signed a message. This can be accomplished via a bitmap B of length |n| managed by the primary, where the ith bit is set to 1 if validator i has signed the message and 0 otherwise.

Nodes can be weighted by some weight function (e.g., represented balance or number of votes), but for simplicity, a notation for equally weighted validators is used. The consensus algorithm has three primary phases to reach consensus: (1) pre-prepare, (2) prepare, and (3) commit.

During the pre-prepare phase, the primary announces a network operation to be considered for consensus, signed by the primary. During the prepare phase, every node checks the validity of the operation and send a signed prepare message to the primary if it agrees the operation is safe and valid. The leader waits for prepare messages from more than 2/3 n of nodes to construct a post-prepare message containing the EC-Schnorr multi-signature of the agreeing nodes along with the corresponding bitmap identifying those nodes. At the commit phase, upon receiving proof that more than 2/3 n nodes signed prepare messages for the operation (via the post-prepare message), a node sends a signed commit message to the primary. The leader waits for commit messages from more than 2/3 n of nodes to construct a post-commit message containing the EC-Schnorr multi-signature of the committing nodes along with the corresponding bitmap identifying those nodes. The post-commit is then disseminated across the network 100 as proof that consensus has been reached, and all nodes update their ledgers accordingly.

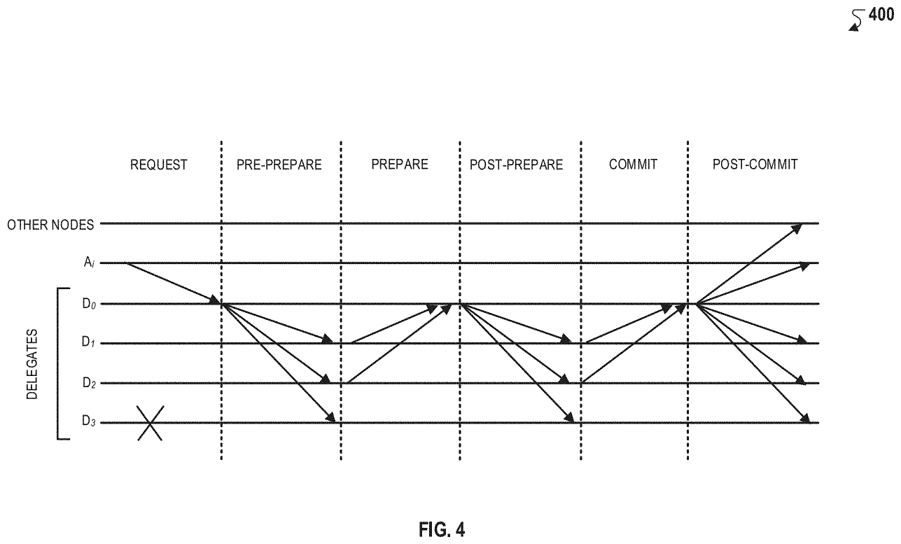

FIG. 4 illustrates an example of a technique for sending messages between a requesting account, delegates, and other nodes during normal operation. In this example, messages in the consensus algorithm are transmitted via communication trees. In the event of a tree fault (e.g., if the primary has not received sufficient responses after a predetermined period of time), the primary falls back on non-tree based communication. Assuming a binary tree, this reduces the number of messages in each validation step to three for a single node. Communication trees do increase confirmation latency by requiring up to O(log₂ n) message relays to get from a single node to the primary, but they reduce overall bandwidth demands and better balances it between nodes. Since capacity is primarily bandwidth-bound, this can result in a net performance gain.

In some instances, where communication tree failure is likely, the consensus algorithm can be configured to use randomized communication groups. This structure involves dividing nodes into randomized groups, each of which has a group primary selected by the primary that is in charge of gathering messages from group members and relaying them to the overall primary. In the event of failure in a group primary, the primary can replace it with another member of the group. Communication can be handled in a variety of ways within each group, such as via trees, gossip protocol, or multicast. More detail on verifiable randomness in the network 100 is discussed below.

The network 100 allows for concurrent processing of network operations, in particular with account requests. In the event that dependent operations are simultaneously considered, nodes topologically sort requests and construct a dependency graph. They then process the requests in the implied order.

There are several ways of handling conflicting operations. The problem can be greatly simplified since account requests referencing the same parent (e.g. double spends) are the only conflicting operations that can exist. Epoch blocks, which constitute the record of all account requests processed in that epoch plus results of votes, are deterministic since all nodes agree on both by construction. Similarly, bounty requests are not specific to an account since rewards can be distributed pro rata with transaction fees, so they too are deterministic.

In the case of conflicting requests for a single account, the simplest solution is to reject all requests and ignore that account until the next epoch, when the conflicting requests are no longer valid. An exception is if a single request has prepare messages from more than 2/3 n nodes, in which case the node commits that request and ignores others, and the consensus algorithm proceeds normally. Due to the account chain structure and conflicting requests from a single account can only occur intentionally so temporarily freezing an offending account protects the network 100 from related attack vectors. The ability for the network 100 to punt on a fork decision without holding up normal functionality of the rest of the network 100 can be a major advantage of the network 100 compared to other crypto or blockchain networks. Proofs of the consensus algorithm's safety and liveness guarantees discussed below.

b. Delegates Election

Delegates can be elected for each epoch Eᵢ ∈ E from among the representatives in epoch Eᵢ-3 during the following stages: (1) candidacy, (2) voting, an (3) certification. During candidacy stage, to be eligible for election, representatives send messages declaring their candidacy to representatives are distributed via a gossip protocol during epoch Eᵢ-3. During the voting phase, each representative votes by distributing its voting power among the candidates (i.e., cumulative voting) during epoch Eᵢ-2 and sends this vote to every other representative via a secure multicast-based broadcast algorithm, which ensures that all honest nodes see the same votes. For security, each vote message includes a hash of the previous epoch block, a timestamp, and a message signature. When a representative is found to have cast more votes than allowed by their voting power (i.e. the sum of votes cast can be no greater than V(rᵢ)), their stake is slashed. Although this process may not very efficient, it has minimal impact on overall network performance since elections happen infrequently. During the certification stage, the top K vote receivers are selected as delegates for Eᵢ. For the purposes of voting consensus, the voting power of any delegate is capped to 1/6 and renormalized. This restriction can prevent edge cases where any one node can have greater than 1/3 of the voting power and grief the network 100 by delaying responses and avoiding slashing conditions. A merkle tree of voting results and a list of delegates are included in the block for epoch Eᵢ-2 on the archive, which certifies the election results. The delegate with largest voting power is the leader for the epoch and has the first chance to propose the block for that epoch, as described below.

Delegates serve terms of I>3 epochs, balanced such that each election determines 1/I of the next epoch's delegates. This ensures that at least 1/3 of delegates for each epoch are non-Byzantine and are aware of all requests that were being considered in the previous epoch, which prevents any potential double spending over different epochs. In the event of a recall, all requests can be halted until the new delegates have been determined.

The voting process does not require an explicit quorum, instead relying on economic incentives to ensure an adequate portion of the network 100 is involved either directly or indirectly. This allows the network to continue to function in the event of an extended partition. Provided non-pathological network connectivity, the most likely cause of such a partition is a large portion of representatives dropping offline within a short time period. In this scenario, there will be no fork of the network 100 as the remaining nodes will maintain consensus.

If a representative fail to broadcast a delegate vote for several epochs, they can incur a small penalty proportional to their constituent balance. This penalty incentivizes maximal voter participation, which helps provide security guarantees.

c. Governance Votes

Any representative can propose a governance change to an allowed parameter. The signed proposal is disseminated via the gossip protocol, and the proposal is voted upon in the same epoch by representatives according to the consensus algorithm, with the proposer acting as leader. If successful, the governance changes are recorded in that epoch's block and are effected in a subsequent epoch, depending on the parameter changed. For example, a change to the number of delegates would need a lag of 3 epochs since delegates are chosen two epochs ahead of time.

Governance proposals may require a high transaction fee as well as substantial proof of work compared to normal requests to prevent spam attacks, since governance votes require a large number of messages.

System variables can be modified by governance votes. Examples such variables include the number of delegates, the minimum bond for a new account, minimum transaction fee, minimum stake for delegate, minimum stake for representative, required proof-of-work for various requests, distribution of transaction fees between various account types, epoch time, constituent balance penalty parameter, pseudorandom function for load balancing. In some implementations, other types of system variables can also be modified.

d. Request Processing

Accounts can send requests to a single delegate who is designated as the primary for that request as it is processed, similar to the construct of the PBFT algorithm, as discussed above. If a leader proves faulty (Byzantine or offline), the account can resubmit the same request to another delegate after a short period of time Lᵣ, where Lₚ<<Lᵣ<<L_{E} for expected processing time Lₚ and epoch time L_{E}. This allows an account to maintain liveness without allowing it to spam the delegates.

To balance the request load amongst delegates, clients can select a delegate according to a delegate selection function, DS, that pseudo-randomly selects a delegate j. That is, for request m sent by aᵢ ∈ A

DS(m)≡j mod |D| (2)

Any pseudo-random collision resistant hash function can be used based on the governance protocol and deterministic ordering scheme (i.e. ordered by the cumulative representative weights) without needing to prove randomness. As a practical matter, this can ensure that honest clients do not overload a single delegate with requests. While Byzantine accounts may collude and send all requests to a single delegate, safety and liveness is still ensured given ultimate usage of the standard PBFT three commit protocol. To identify accounts attempting to circumvent the load balancing, delegates can validate that messages from said account should be directed toward them. Each delegate will ultimately see most valid requests, but this additionally allows invalid requests to be efficiently filtered out by individual delegates before consuming resources of other delegates.

Requests received by a single primary delegate can be easily batched together for joint validation to reduce the overall number of messages without any other changes to request processing. Since each request is assigned to a specific primary, there is no duplication across batches of requests.

Every request includes a transaction fee. These fees are pooled together and distributed to representatives and delegates according to several factors, such as constituent balance, bonus for delegates, bonus for the delegate that successfully proposes the epoch block. Rounding can be used to ensure invariants such as total token supply is not broken. Balances confiscated for violations of slashing conditions can be added to the transaction fee pool and distributed accordingly.

Since the cost of running the network 100 can be substantially less than proof-of-work systems and the network 100 is highly scalable, there will be little upward pressure on fees, and they should be de minimis for any size transaction. Nevertheless, they are critical for properly aligning incentives in the network. The network 100 therefore incentivizes nodes to actively validate requests by rewarding them in proportion to the actual cost of validation. Additionally, the network 100 indirectly incentivizes accounts to include their balances in voting, ensuring that a large percentage of network value is securing the network 100. Further, during periods of extreme volume (e.g. in the early stages of the network before large, professional validating nodes have been formed and node hardware can't keep up with transactions), it allows the network 100 to maximize social utility by processing transactions from accounts that get the most utility from their transactions.

The network 100 can operate at far below the capacity of even average consumer hardware for a long time due to its efficient design, so zero-fee transactions will be able to be processed. Additionally, the network 100 can reserve a portion of the total token supply to initially subsidize transactions.

Transaction fees can be claimed from a pool after an epoch block is approved by the network 100. Delegates who failed to validate a request and representatives that fail to vote during an epoch lose their claim to the transaction fees and penalty distributions. Unclaimed fees can be added to the subsequent pool. Provided that epoch length is several orders of magnitude greater than transaction processing time (by construction), these reward requests will only represent a de minimis portion of overall network transactions.

e. Epoch Block Processing

Epoch blocks contain the various types of information, such as merkle tree of account requests committed during that epoch, merkle tree of delegate election results for epoch i+2 and list of delegates, a list of representatives for the epoch i+2 and their voting power, successful governance changes and a merkle tree of the vote, and a transaction fee pool.

Epoch blocks are deterministic, and adding them to the blockchain is a pro forma process. All honest nodes have the same view of all block contents (after accounting for network latency), and they will reject any block that does not match that view exactly. If a node does not have a record for a request that is included in the block or disagrees with it, they can query the block proposer or other nodes for the transaction. This process is important for synchronizing the global state across nodes and uncovering slashing violations.

The two epoch delay for delegate elections and representative changes, as well as a minimum two epoch delay for governance changes, can be used to ensure that all changes are known deterministically by all nodes well before the start of a new epoch. Blocks can be confirmed by the set of representatives via the consensus algorithm discussed above. The lead delegate for an epoch has the first chance to the propose the block, then delegate who received next amount of votes, and so on, until a delegate with a valid proposal has been found. Practically, this can take the form of a timeout for each proposal slot. To incentivize efficient block creation, an epoch block can be added to the archive before transaction fees can be claimed, and the successful proposer gets a bonus payment. Delegates who fail to propose a successful block forfeit any transaction fees.

A recall also ends with a block added to the archive as it closes an epoch. If delegates are unable to put together the correct block, representatives can force it through a recall.

f. Slashing Conditions

The network 100 can use slashing conditions as slash able offenses. As an example, for a false representation, a node can send a prepare or commit message for a transaction that is invalid in some way, including referencing an uncommitted parent block, sending more than the current balance, sending frozen funds, or referencing the incorrect epoch. For a double prepare, a node can send prepare messages for two conflicting requests in the same epoch. For a double commit, a node can send commit messages for two conflicting requests in the same epoch. For a conflicting prepare/commit, a node can send a prepare message and a commit message for two conflicting requests in the same epoch. For double voting, a representative cast more than one delegate or governance vote in a single epoch.

The slashing schemes discussed above can be designed to be simpler than many other slashing schemes that are often used but be capable of maintaining desired properties, such as accountable safety and plausible liveness. This is partially due to novel chain structure of network 100, where forks and reorgs can only occur intentionally. This greatly can reduce the set of pathological scenarios where nodes must be slashed for the network 100 to continue processing requests.

When balances are slashed, they go into the normal transaction fee pool and can be distributed accordingly. This wide distribution is often preferable to allowing a single account to claim the slashing reward, as it prevents a Byzantine account from claiming its slashed balance with an alternative account and creates an economic incentive for all nodes with a balance to monitor for slashing conditions. An additional benefit is network efficiency because, for example, each node only requires one receive request for all transaction fees and slashing penalties that they are entitled to during an epoch. Thus, total request complexity is O(n) for the pooled distribution, a substantial improvement over the O(kn²) complexity for direct distribution of k fees and penalties.

Functionally, slashing can work as a special send to the transaction fee pool that is involuntarily added to account chain of the offending account. After the slashing condition has been discovered, any node can send this slashing request to a delegate for consideration, and delegates validate it as any other request. If the delegates are unable to commit the slashing request in the epoch which it occurred, any representative or delegate can initiate the consensus algorithm. Since the request can only take one form (i.e., a send of a portion of the offender's account balance and deposit to the transaction fee pool), there are no race conditions between different nodes.

A slashing offense is highly unlikely to go unpunished if discovered by even a single honest node acting rationally, as that node has an economic incentive to publicly broadcast the offense. Since slashing offenses are only dangerous in so far as they impact honest nodes, these conditions offer a credible deterrent for any potential violators.

Slashing conditions can be robust to more than 1/3 of delegates or representatives acting Byzantine, even if valid slashes cannot be effected immediately. Staked funds remain frozen for a long period of time, which will give accounts sufficient time to redirect balances to honest representatives, who will then elect honest delegates. These honest delegates will still have time to slash the balances of the offenders before they thaw.

g. Polis State Shading

The network 100 can have a state sharding scheme as another component that contributes to network scalability. Sharding involves breaking the network 100 into disjoint groups that independently validate requests in parallel, thus allowing the network to scale in the number of validators. Each account can be pseudo-randomly assigned to a shard, and shards process all requests from member account.

The structure of the network 100 can be uniquely conducive to and optimized for sharding. For example, by maintaining a request chain for each account, the network state can easily be partitioned into groups. Other features, such as separating sends and receives, minimize the need for inter-shard synchronicity and communication, can also be implemented.

Sharding increases network vulnerability to some attack vectors, so special care can be taken to ensure that guarantees are maintained with high probability. Given a sufficiently large number of representatives relative to the number of shards (achieved via a cap on representative balances), as well as a source of randomness that is impractical to game, it can be shown that subgroups of representatives violate honest node assumptions with very low probability.

Specifically, let N be the total number of equally-weighted validator nodes, of which K are Byzantine, that will be split among S shards, each of equal size

$$n = \frac{N}{S} .$$

Let Xⱼ be a random variable for the number of Byzantine validators assigned to shard j, each of which take on values kⱼ such that Σⱼkⱼ=K. Then the Xⱼ's have hypergeometric distributions with the following joint pdf:

$$P ( {X}_{1} = {k}_{1} , … {X}_{S} = {k}_{s} ) = \frac{1}{( \begin{matrix}N \\ K\end{matrix} )} \cdot {\prod }_{j = 1}^{S} ( \begin{matrix}n \\ {k}_{j}\end{matrix} ) \qquad ( 3 )$$

This can be thought of as the lining up N-K non-Byzantine nodes and placing K Byzantine nodes among them. The number of possible resulting orders is equal to

$$( \begin{matrix}N \\ K\end{matrix} )$$

by the Stars and Bars combinatorial result. Then the first n nodes in the resulting line up are assigned to the first shard, the second n to the second shard, and so on. Since order does not matter within each shard, this is divided by the number of ways to arrange kⱼ Byzantine nodes and n-kⱼ non-Byzantine nodes in shard j, which is equal to n by the kⱼ same result. The probability is then the inverse of the total number of distinct combinations. It is easy to verify that this is a proper pdf that sums to 1 by the generalized version of Vandermonde's identity.

Consequently, the probability that the fraction of Byzantine nodes in any one shard is more than α is:

$$P ( {X}_{i} \leq α , ∀ i ∈ S ) - \overbrace{{\sum }_{{k}_{1}}^{α} … {\sum }_{{k}_{S}}^{α}}^{{\sum }_{i}^{S} {k}_{i} = K} {\prod }_{i}^{S} ( \begin{matrix}n \\ {k}_{i}\end{matrix} ) \qquad ( 3 )$$

where presumably testing is for

$$α \leq ⌊ \frac{N}{3 S} ⌋$$

This distribution can be sampled to estimate the probability of at least one shard violating the Byzantine validator assumption by having n/3 or more Byzantine validators for various levels of N and S. These simulations show that if N≥1000, then for S≤10, the network 100 has a very low probability of a Byzantine violation occurring in a shard.

At mature state, we the network 100 can have at least 1000-5000 representative nodes, which could easily accommodate 10 shards. The exact shard capacity may depend on the real distribution of tokens among accounts, with capacity maximized under a uniform distribution. Security measures, such as capping the voting power of any one representative in a shard, would partially mitigate the risk from large balance accounts and encourage large stakeholders to allocate to several accounts, which could improve inter-shard communication.

The network 100 can also be designed to be careful to prevent adverse balance redistributions between shards that could be used to violate these assumptions. For example, representative balances can be locked before assignment to a shard. Additionally, inter-shard communication can be used to help police behavior and provide finality. Shards periodically share internal states globally and collectively cement the overall state in the main archive to ensure system-wide consensus. If a node detects adverse behavior, such as a violation of a slashing condition, then proof can be broadcast to other shards to adjudicate and penalize the offender.

Representatives rᵢ (identified by their account) can be assigned to shards by a bias-resistant public random function based on RandHound that has complexity O(c² log n) given a group size c. To achieve this, we require a one-time setup phase that securely shards nodes into subgroups and then leverages aggregation and communication trees to generate subsequent random outputs. The random output r^{\hat{ }} is unbiasable and can be verified together with corresponding challenge c^{\hat{ }} as a collective Schnorr signature against the collective key. Effectively, through utilizing NIZK and PVVS, public verifiable and unbiased randomness can be generated on demand. This function is abstracted as S_{R} that produces an output hash hᵢ:

S_{R}(r^{\hat{ }})→hᵢ

These hash outputs are then ordered, and the first

$${n}_{S} = \frac{\vert R \vert}{S}$$

representatives are assigned to the first shard, the next n_{S} are assigned to the second shard, and so on.

Sharding assignments can occur every M epochs. After sharding occurs, the representatives assigned to each shard elect shard delegates to validate requests assigned to that shard and propose epoch shard blocks in the same manner as in the unsharded system. There can be additionally system-wide delegates that receive all request commitment proofs and epoch shard blocks to ensure proper functioning. These system delegates are in charge of constructing archive blocks that serve as checkpoints for the entire network. M can be chosen to balance the mixing frequency of shards with system overhead.

Non-representative account aᵢ can be assigned to shard j by a deterministic function S_{A} modulo the number of shards.

SA(aᵢ)≡j mod |S| (5)

All requests originating from an account are processed by its shard's delegates. By design, each account can function completely independently of other accounts, which makes this division simple. Since unsettled incoming balances are secure, accounts under most circumstances will be able to wait for the end of an epoch block when all shards sync to that checkpoint to issue receives for sends from outside the shard. If the funds are required immediately, the account can issue a cross-shard receive. Transaction fees will be distinct for intrashard and intershard requests, which will allow the network to appropriately process transactions in an order that maximizes social utility.

Models can be used to estimate that sharding can increase transaction throughput by at least an order of magnitude to more than 100,000 transactions/second, enabling the network to exceed the capacity of centralized payment networks. It also can reduce average confirmation time to less than 1-second and decrease transaction fees, which will further open the network 100 to applications requiring rapid and cheap transactions.

### D. Network Extensions

In various implementations, the network 100 can be configured to provide various network extensions, such as smart contract capabilities and broad ecosystem expansion, as discussed below.

a. Bounded Smart Contracts

In some implementations, the network 100 can be configured to have native scripting and data that enables richer and smarter requests. These functionalities can be purposefully limited so as not to hinder the network's primary goal of optimal value transfer. The scripting language can be sufficiently rich to enable conditional transfers, side channels, cross-chain support, basic privacy, and other accretive functionality, but will also be more constrained than Turing-complete smart contract systems to prevent the chain from becoming bogged down in complex computation.

The scripting language can be used to enable development of smart contracts on top of the network 100. For example, the smart contract layer can exist entirely separately from the base settlement layer, which segregates functionality to preserve modularity and flexibility. By limiting the capabilities of smart contracts, a balance can be established between preserving network throughput while enabling some compelling use cases. For instance, smart contracts can execute on a virtual machine, which can include compilers for many common, modern programming languages. In such implementations, an emphasis can be placed on code security, testing, and formal verification, to develop tools that empower users to easily deploy robust contracts.

b. Network Ecosystem

In some implementations, the network 100 can be associated with a supporting ecosystem. The ecosystem can include a full range of clients, from full nodes run by validators or exchanges to light nodes run by IoT devices. In such implementations, clients can be available for desktop, mobile, and web platforms, and a heavy emphasis can be placed on global accessibility and usability.

The ecosystem can support certain use cases of the network 100, such as providing payment services, point-of-sale systems, peer-to-peer payment applications, e-commerce plugins, invoicing applications, among others. Additionally, the ecosystem ca be used to empower Internet communities as a whole to produce other applications, such as crowdfunding applications, accounting software, IoT integration, and payroll applications, while also producing competing solutions to core uses. As such, accessible APIs can be available in a variety of languages, enabling easy integration into web frameworks and development stacks.

User-friendly features can also be implemented through the ecosystem supporting the network 100. For example, an address name service can allow human-readable account addresses similar to emails. This can facilitate easy raw transactions independent of any client. Other features can further abstract the base protocol for the average user, reducing costly errors and improving accessibility.

### E. Applications and Use Cases

The chain mesh network discussed herein can be implemented in different applications that require efficient and secure transfer of value. Some examples of such applications are discussed below. Other applications of the chain mesh network are also contemplated using the techniques discussed throughout this document.

a. IoT Micro-Transactions

IoT devices often require the ability to interact with and transfer value to other devices on a trustless basis. The chain mesh network discussed herein can be used to provide an ideal solution to economically connect the IoT. For example, the network 100 can offer unbounded scalability, rich transactions, and minimal transaction fees, enabling frictionless and intelligent transfers. In some implementations, the network 100 can be designed and/or configured to accommodate low footprint light clients that can run on limited hardware without having to continually trust a third party full node. Additionally, programmability of the network can allow for interoperability with other networks used by IoT devices, both public and private.

b. Merchant Payments

Merchants often require secure payment networks that provide both high transaction throughput and low confirmation latency. The chain mesh network can be designed around these qualities, and the ecosystem supporting the network can be used to develop applications that enable seamless network integration with merchant systems. The network can offer additional benefits of global usability (particularly valuable for internet commerce), low fees (orders of magnitude cheaper than the 2.5% charged by credit card networks), and transaction finality (which will reduce losses due to fraud and charge backs). The network is also able to finalize transactions faster than other cryptocurrencies due to its chain mesh structure, which allows merchants to be confident that transactions will not be reversed as soon as they are approved. This can be used to reduce fraud, such as improper charge backs, and savings can be passed on to consumers. The network can also include a cryptographically secure account system that reduces the risk of theft, protecting users in the event of data breaches and removing the need for trust in online payments.

c. Peer-to-Peer Transfers

The chain mesh network can be an entirely open and trustless, enabling individual anywhere in the world to join the network and transact with other users in a decentralized manner. Compared to centralized peer-to-peer payment solutions, users always control their funds, so they cannot be frozen or locked up arbitrarily. The network ecosystem can also include frameworks that will empower secure and simple peer-to-peer transactions. This functionality can be extended to a diverse range of applications, including game economies, international remittances, and alternative payment systems for countries with unstable currencies.

d. International Trade and Reserves

Many countries often welcome the opportunity to settle corporate accounts in a currency independent from any single country or central authority. Currently, most countries need to hold large reserves of international currency to facilitate trade that occurs in dominant currencies like USD and EUR. Countries like China (exports priced in USD) and Russia (commodities priced in USD) are deeply uncomfortable with this status quo, as it ties a substantial portion of their economy to a foreign government and central bank. A non-sovereign, trustless crypto network, such as the network 100, is far preferable as a reserve. Furthermore, the secure and fast transaction capabilities of the network can be an attractive option for companies transacting with foreign entities, as it substantially reduces risk and settlement times while being easy to integrate.

e. Store of Value

Digital assets are often ideal stores of value since they are open, decentralized, cryptographically secure, censorship-resistant, mostly non-inflationary, cheap to store, and increasingly easy to use. The chain mesh network discussed herein, as a scalable, highly secure, and minimally frictional payment system with interoperability with other systems, is an ideal digital asset for store of value. A few dominant transaction-focused digital assets will likely win out as stores of value and have a high chance of displacing much of the $3 trillion of gold used for store of value and the $12 trillion of national fiat currencies held as reserves. Store of value is thus one of the highest potential source of digital assets value, and the chain mesh network discussed herein can be well positioned to capture a portion of that value.

### F. Other Implementations

a. Multiple Chains per Account

In some implementations, the network 100 can be configured to store (or otherwise associate) multiple chains per account. For example, the network 100 can store two chains for each account—a first chain for outgoing send transactions provided from the account, and a second chain for incoming receive transactions at the account. This architecture reduces computational overhead on the network 100 and facilitates a greater volume of transactions while reducing complexity for an end-user. Importantly, separating the send and receive chains allows for any number of receive transactions for a given account to be concurrently processed at the same time as a send transaction without locking the account. Global ordering of the receive transactions is achieved via the timestamps assigned the corresponding send transactions during their consensus. In some implementations, additional chains can also be created for other purposes beyond send/receive transactions, such as staking to facilitate the computation overhead.

b. Bootstrapping

As described herein, “bootstrapping” refers to a process by which a network node syncs up to the current state of the network 100. More specifically, bootstrapping refers to the process by which blocks from a peer are downloaded and applied to a client node in order to get both the client and peer to be in sync with each other's database. For example, if a node is brand new, it needs to obtain the correct database from its peers as it starts off with no data. In this example, bootstrapping refers to the process by which the new node obtains these blocks. Another use-case is when nodes fall out of sync with the network 100. For example, when a given node crashes or needs to be restarted, it has to sync up with the network 100 from the current state once it comes back online.

The bootstrapping process is invoked when a timeout expires and is run every n seconds. It can also be invoked directly by consensus in the event that our database is out of sync. The bootstrapping process may be needed because it is possible that a given node is not up to date with the rest of the network 100. This can happen in the event a new node comes online, or in the event that the node crashes and therefore needs to sync up with the network.

As discussed below, the bootstrapping process determines if it is in sync using the tips database and sequence numbers. It compares the sequence numbers of each tip, and upon realizing that the client does not have the same sequence number, it will then initiate a download of the blocks from the peer, a process referred to as a “pull” in the source code.

The bootstrapping approach taken can be used to update batch state blocks, micro-blocks (discussed below) and epoch blocks. The state blocks are not updated using accounts or individual state blocks. All the blocks are serialized/deserialized instead of being copied. This approach provides the advantage of serializing only what we need for the batch state blocks increasing performance of the system.

Generally, bootstrapping can be initiated in an alarm, and starts off by getting the information needed to decide if a node is ahead or behind. This information, referred to as “tips,” represents the last blocks in the database for a given chain. The system decides if it is ahead by checking sequence numbers on the peer. In the case where the bootstrap node is actually ahead of the bootstrap peer, the sequence numbers of the peer will be less than those of the bootstrapping node. Once this is determined, the peer is not bootstrapped, and the peer initiates a bootstrap on its end to sync up. In such instances, blocks are not pushed to peers.

Once the system decides that it is behind (i.e., the sequence number is less than the peer), a pull request is issued for the blocks that are determined to be behind. Once the blocks are received, they can be validated and applied to the database. Note that the order of retrieving blocks works by going micro-block to micro-block such that each of the batch state blocks of the current micro-block is downloaded and validated/applied prior to the current micro-block. Once the batch state blocks are all applied, they are validated/applied to the current micro block. The system then proceeds to obtain the next micro block. If the system reaches the last micro-block in an epoch, the next micro-block and the next epoch is obtained after the current epoch is validated.

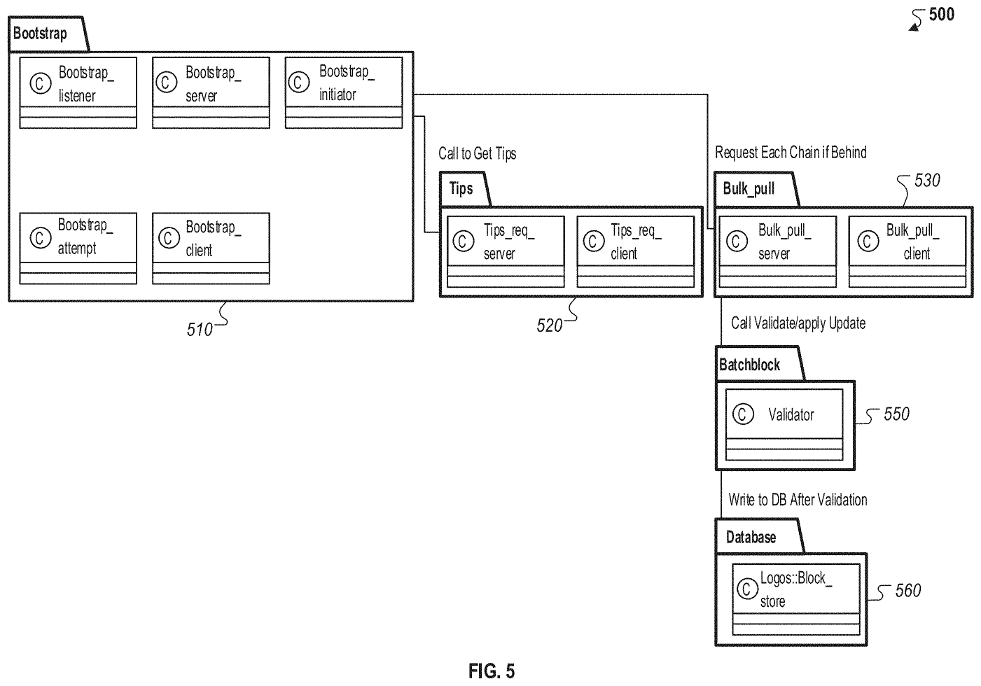

FIG. 5 is a conceptual diagram of an example of a bootstrapping sub-system 500. The sub-system 500 includes a bootstrap module 510, a tips module 520, a bulk pull module 530, and bulk push module 540 (not shown), a batch block module 550, and a database 560. The modules of the sub-system 500 can represent software that execute code (e.g., helper classes or structures) to implement the bootstrapping process described throughout.

As shown in FIG. 5, the bootstrapping module 510 includes five main classes, including “bootstrap_listener,” “bootstrap_server,” “bootstrap_initiator,” “bootstrap_attempt,” and “bootstrap_client.” These classes can represent low-level multi-threading code as well as networking code. The tips module 520 includes two main classes of “tips_req_client” and “tips_req_server.” The bulk pull module 530 and the bulk push module 540 each include two main classes of “bulk_pull_client” and “bulk_pull_server.” The batch block module 550 includes a single class of “validator.” In some implementations, code for the sub-system 500 includes approximately 4400 total lines of code.

The sub-system 500 performs bootstrapping by updating batch state blocks, micro-blocks and epoch blocks. In some instances, blocks are not updated using accounts. In such instances, the basic algorithm is as follows:

while (true) {
get tips from peer
if behind for delegate i
request a pull request
}

Subsequently, bootstrap logic will issue a request from the peer for the pull requested as follows:

while (still_pulling) {
send peer a request for the pull
receive the response in the form of a
block type
}

The sub-system 500 can support retrieving epoch, micro, and batch state blocks. The sub-system 500 aims to send epoch and micro blocks first, followed by batch state blocks. As these blocks arrive, they are queued and processing occurs when we reach either an end of transmission (referred to in the code as a “not_a_block”) or we reach a predefined limit of how big the queue should get. At that point, the sub-system 500 sorts its batch state blocks, and iterates through the sorted list calling the consensus validate method on the batch state block. Once a block is validated, it is written to the database 560 via consensus ApplyUpdate method. After the database 560 is updated, the sub-system 500 checks to determine if a micro block has been reached based on the tips module 520, and if it has, the sub-system 500 validates and applies the micro-block using the code methods of the micro-block. Once the sub-system 500 reaches an epoch block tip, same technique is applied for an epoch block. If there is nothing that validates, the sub-system 500 will wait for new arrivals from the network 100. As blocks are written to the database 560, the sub-system 500 removes them from the queues.

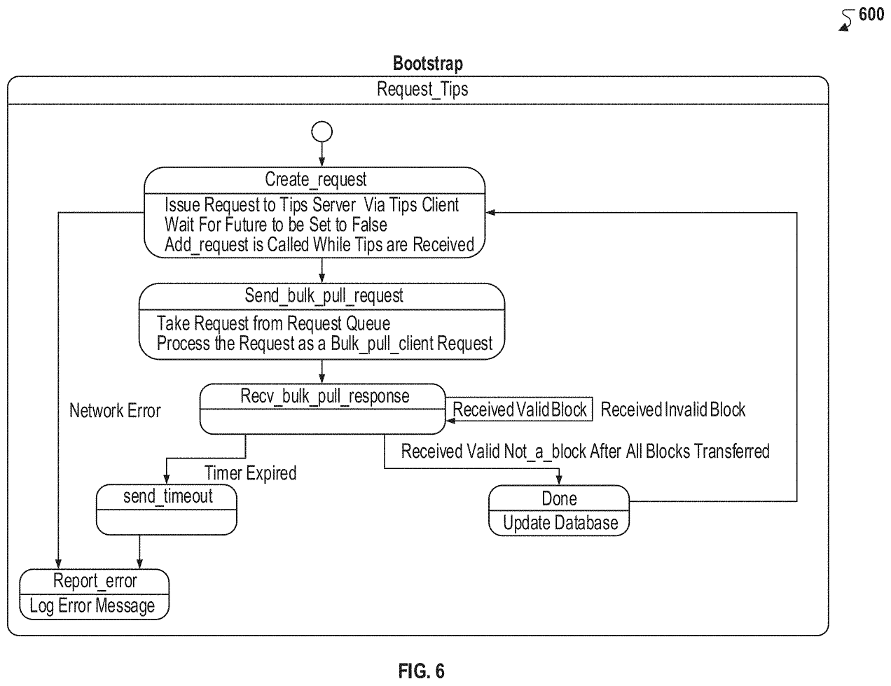

FIG. 6 is a state diagram that illustrates an example of a bootstrapping process 600. The process 600 generally involves an initial sequence for initiating bootstrapping, responding to tips request and setting up a pull request, responding to a pull request, and validation of blocks.

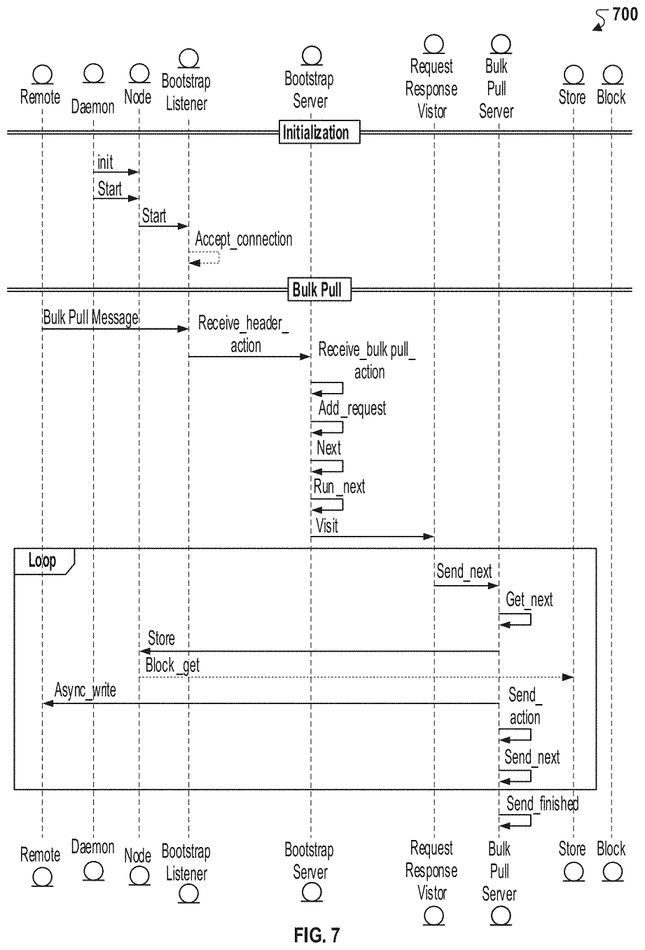

FIG. 7 is a conceptual diagram that illustrates a sequence 700 for bootstrap initialization and the start of bulk pull requests. As shown in FIG. 7, a bootstrap initialization process initially occurs. A bulk pull process is then performed by obtaining a bulk pull message. A loop process then occurs for each micro-block as described above.

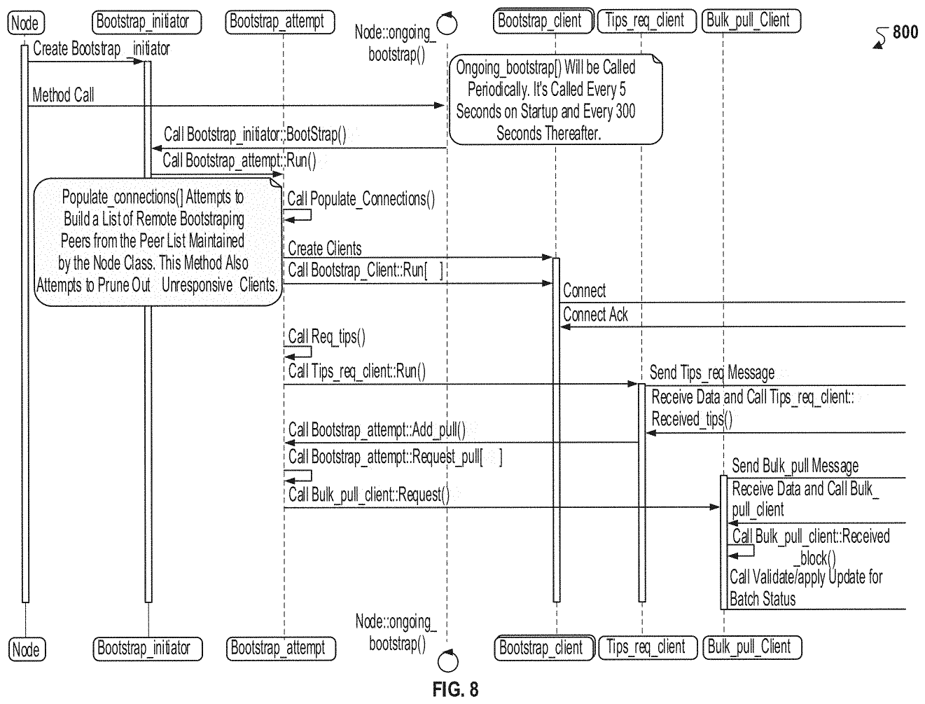

FIG. 8 is a conceptual diagram that illustrates how a bootstrapping process 800 operates when it is up and running. As shown in FIG. 8, a “node” class initially creates a bootstrap initialization using a “bootstrap_initiator” class (shown in FIG. 7). The node then performs a method call where a “ongoing_bootstrap( )” method is called periodically (e.g., every five seconds on startup and every 300 seconds afterwards). The “bootstrap_initiator” class then calls a “bootstrap_attempt::run( )” method, which results in “populate_connections( )” method to be called.

The “populate_connections( )” method attempts to build a list of remote bootstrapping peers from the peer list maintained by the “node” class. This method also attempts to prune out unresponsive client.” The “bootstrap_attempt” class then creates clients on the “bootstrap_client” class and calls “bootstrap_client::run( )” method. This results in the “bootstrap_client” establishing a connection with the “remote” class, and receiving an acknowledgement of the connection from the “remote” class. The “bootstrap_attempt” class then calls “req_tips( )” and “tips_req_client::run( )” methods, which results in the “tips_req_client” class sending a “tips_req_message” to the “remote” class, and receiving data from the “remote” class and calling “tips_req_client::received_tips( )” method.

The “tips_req_client” class then calls “bootstrap_attempt::add_pull( )” method to the “bootstrap_attempt” class and calls “bootstrap_attempt::request_pull( )” method. The “tips_req_client” also calls “bulk_pull_client::request( )” method to the “bulk_pull_client” class. This results in the “bulk_pull_client” class sending a “bulk_pull” message to the “remote” class, receiving data from the “remote” class and calling the “bulk_pull_client::received_type( )” method from the “remote” class. The “bulk_pull_client” class also calls “bulk_pull_client::received_block( )” and “Validate/ApplyUpdate” methods for batch state blocks, micro-blocks, and epoch blocks.

In some implementations, the system can be configured to perform parallel bootstrapping. As described herein, “parallel bootstrapping” refers to the process by which a node will bootstrap with a set of networked peers. The node selects peers from a list and tries to bootstrap from them. In such implementations, the system maintains a list of peers using either p2p module or our list of delegates. The list is a set of boost asio endpoints. Then, in order to bootstrap, the system selects a peer from the list in an iterative way. The peer is then queried for its tips. The selection of peers happens in “populate_connections( )” by calling a “bootstrap_peer( )” method. Once the system obtains a peer, it by checking tips. If the system is not in sync, it will request blocks by iterating through micro-block by micro-block. When a micro-block is downloaded, its bsb blocks are requested in separate pulls. Each pull may be requested on a separate peer. When the system ha sail the bsb blocks, it will proceed to validating the micro-block, and only then, will the system advance to the next micro-block. Each pull request can potentially be from a different peer.

Each request can be made to a separate peer and each peer responds with the blocks that were asked of it. The system will need to integrate with p2p peer list and incorporate blacklisting. In some instances, the design for blacklisting is to re-use the p2p code for this, and then to keep track of which IP address sent us which block (using the IP Address or an integer representing the peer in the list), and when a criteria is reached, such as maximum number of retries, the system can decide to add the peer to a blacklist. The API should include adding the peer to the list (perhaps using a boost endpoint as a way of identifying the peer) and a way to check if the peer is in the blacklist. To implement this, the system would check in “populate_connections( )” if the peer is blacklisted, and avoid using that peer for a connection. When the system decides that a block is no good (e.g., in the “validator” class), it can add the peer to the blacklist. The p2p peer list has to keep the current set of peers to communicate with and has to populate the bootstrapping peer list (or the system can change the implementation of “logos::peer_container::bootstrap_peer” to return a “logos::endpoint” based on what is in the peer list and perhaps taking into consideration if the peer is blacklisted or not).

In some implementations, the system can be configured to consolidate tips into one message. As discussed above in reference to FIG. 5, the bootstrapping node can send its tips information to the peer. The peer will use that information to decide if it is ahead or behind. If it is behind, it will initiate bootstrapping on its end and signal to the bootstrapping node to proceed using another peer. The message containing tips information is a single message that contains information about the epoch block tip, the micro-block tip, and each individual delegates tips as opposed to sending a message for each delegate, we send just one representing a snapshot of the system.

c. Consensus Protocol

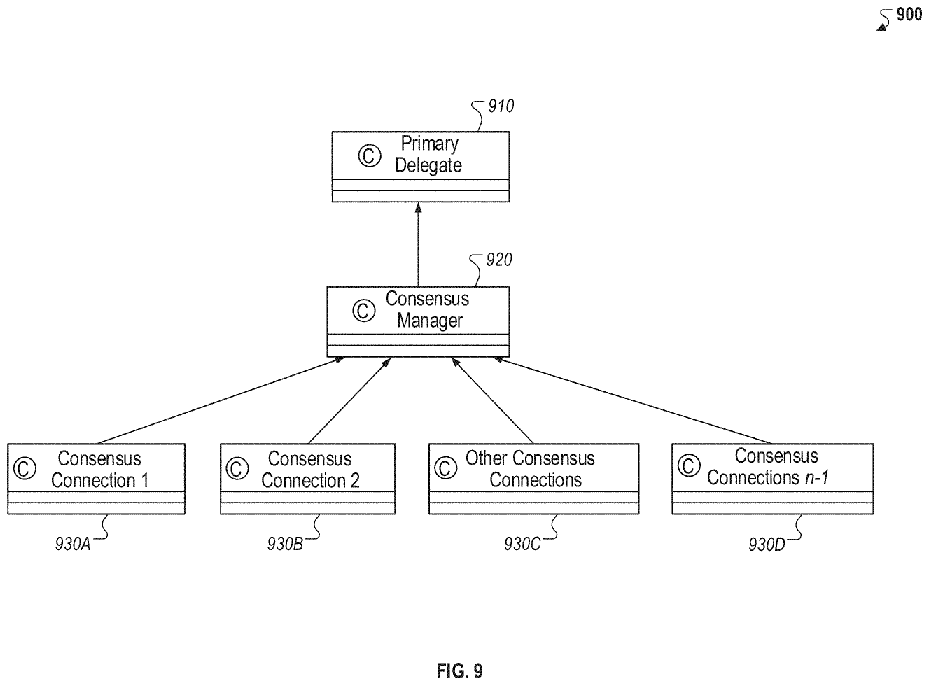

FIG. 9 is a conceptual diagram illustrating an example of a consensus architecture 900. As shown, the consensus architecture 900 includes a primary delegate 910, a consensus manager 920, and multiple consensus connections 930A, 930B, 930C, and 930D.

As discussed above, the consensus architecture 900 can be used to enable practical scalability, fully aligned incentive structure, and security in the presence of Byzantine faults. For example, the base data structure is the network 100, which is a directed acyclic graph (DAG) that includes a dedicated chain of transactions for each account. Transactions are processed in parallel rather than in blocks, and consensus is achieved via using algorithms that provide both liveness and safety as long as more than 2/3 of the nodes by holdings are honest.

In some implementations, the consensus architecture 900 is a PBFT-derived algorithm that allows for large, dynamic node sets to achieve consensus on transactions, votes, and epoch blocks. Each instance of PBFT requires a single leader called the primary to propose transactions and manage feedback from the other validators.

As described herein, the consensus architecture 900 can use Bone-Lynn-Shacham (BLS) signature scheme to allow the network 100 to verify that a signer is authentic. This results in more efficient processing of transactions (e.g., fewer round trip communications between validators per consensus instance). In such implementations, the system can be configured to verify individual account signatures for signing transactions using an Edwards-curve Digital Signature Algorithm (EdDSA) to optimize for speed. As discussed below, the system can enable multiple keys per account with different purposes. In particular, a validator can have two keys: a validation key for signing validation messages, and a transaction key for signing personal transaction messages. This allows the validator to safely expose a validation key of an account online while also keeping funds associated with the account in offline storage with the use of the transaction key.

Referring now to FIG. 9, the primary delegate 910 is responsible for receiving and validating consensus messages sent by backup delegates. The primary delegate 910 aggregates messages sent by backups and upon receiving approving responses from more than 2/3 of backups, responds with a message containing the aggregated signature of the responding delegates. The consensus manager 920 acts as the primary interface for the consensus module and handles the bookkeeping done before consensus is initiated and after consensus is reached by the delegates. Each of the consensus connections 930A-D maintain a connection to a single remote peer. This class is used by the primary delegate 910 to send messages to remote delegates, and also receives messages sent by remote delegates.

The consensus architecture 900 can be executed on top of the Boost asio threadpool. This threadpool is created by spawning threads at the start of the application and calling a “service.run( )” method on each thread. A consensus module then responds to IO events such as transaction requests from clients received from the network, or messages from other delegates.

For each type of consensus (e.g., Batch State Block, micro-block, epoch block, etc.), a delegate node will have one instance of the primary delegate 910 class and n-1 instances of the consensus connection class (where n is the number of delegates in the distributed system). The primary delegate 910 instance can only lead a single instance of consensus at a time. The primary delegate 910 leading consensus and the connection instances serving as backups occur in parallel.

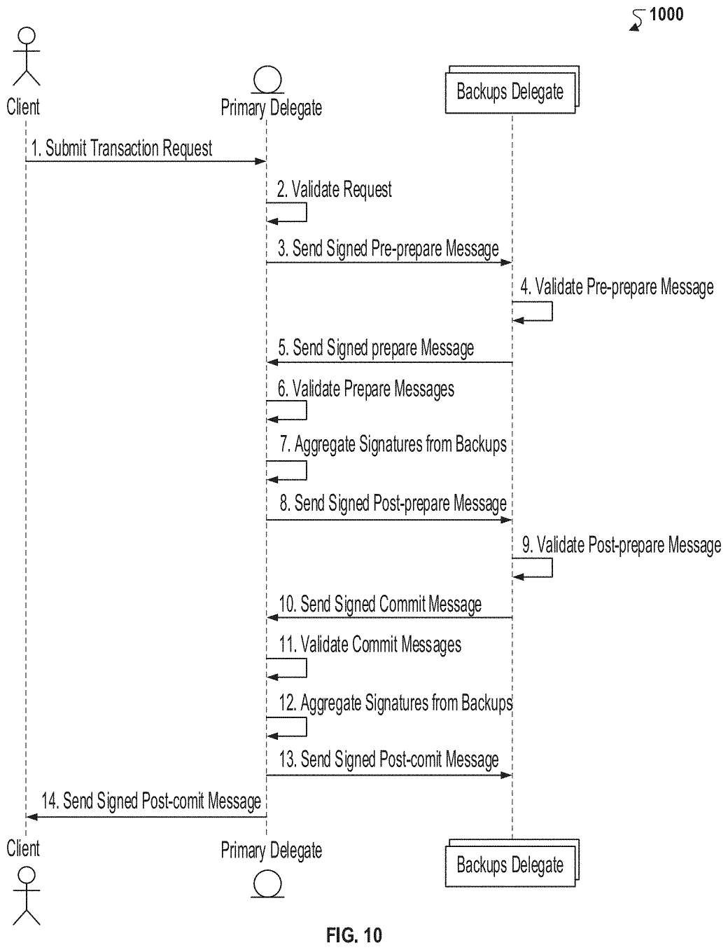

FIG. 10 is a sequence diagram that illustrates an example of a consensus sequence 1000. In this example, the designation of one node as a primary and the rest as backups is determined by the client. The recipient of the client's transaction request will be the primary for with respect to that request, and the others will serve as backups. As shown in FIG. 10, a client initially submits a transaction request to a primary delegate. The primary delegate validates the transaction request received from the client. The primary delegate then sends a signed pre-prepare message to a set of backup delegates.

The backup delegates validate the pre-prepare message provided by the primary delegate, and sends a signed prepare message to the primary delegate. The primary delegate validates the prepare messages, aggregate signature from backups, and sends a signed post-prepare message to the set of backup delegates. The backup delegates then validate the post-prepare messages, and sends a signed commit message back to the primary delegate. The primary delegate validates the signed commit messages, aggregates signatures from backups, and sends a signed post-commit message to the backup delegates. The primary delegate then sends the signed post-commit message to the client.

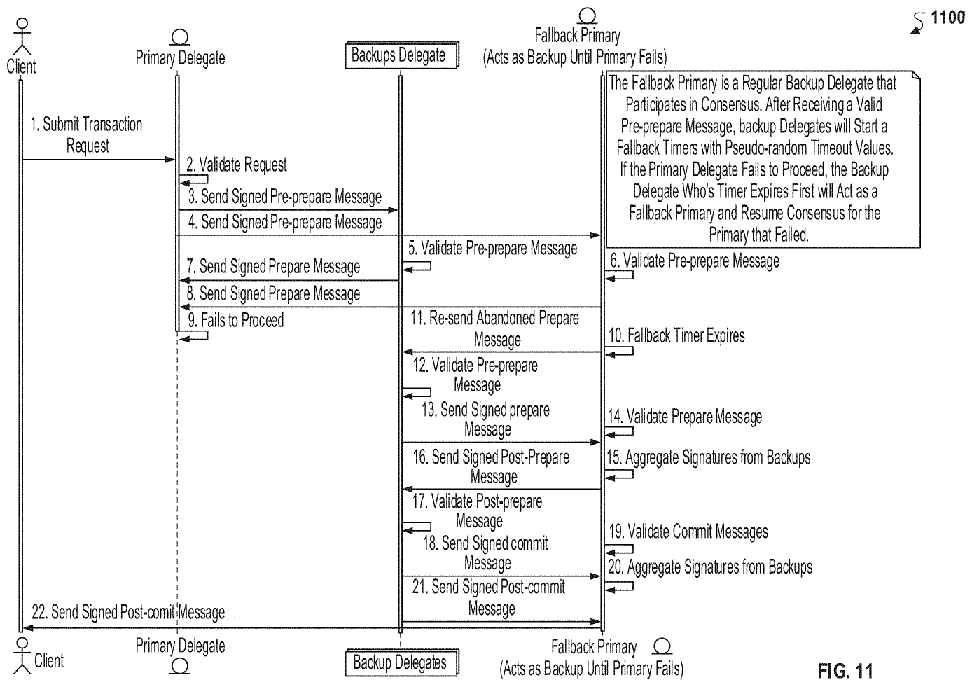

FIG. 11 is a sequence diagram that illustrates an example of a fallback consensus sequence 1100. In this example, a backup delegate resumes a consensus session abandoned by a faulty primary. The fallback primary acts as a backup until the primary fails. As shown in FIG. 11, the fallback primary is a regular backup delegate that participates in consensus. After receiving a valid pre-prepare message, backup delegates will start a fallback timers with pseudo-random timeout values. If the primary delegate fails to proceed, the backup delegate whose timer expires first will act as a fallback primary and resume consensus for the primary that failed.

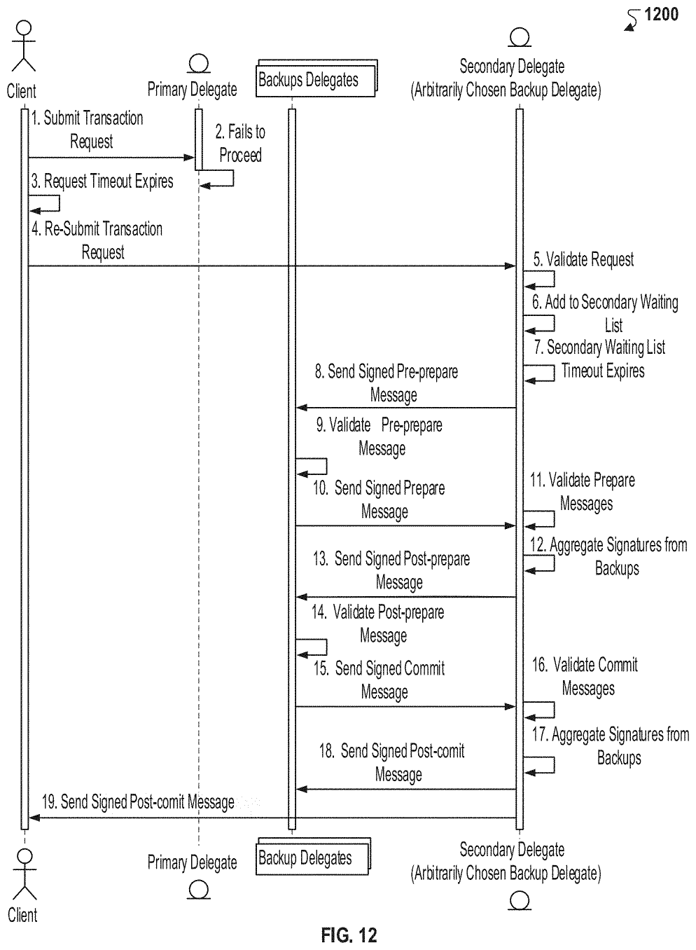

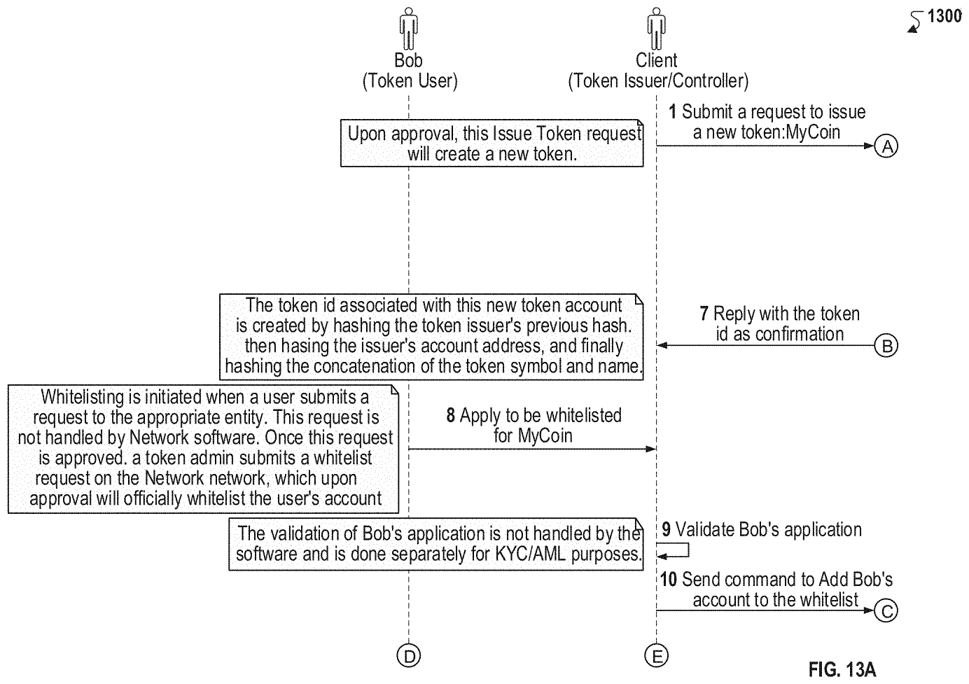

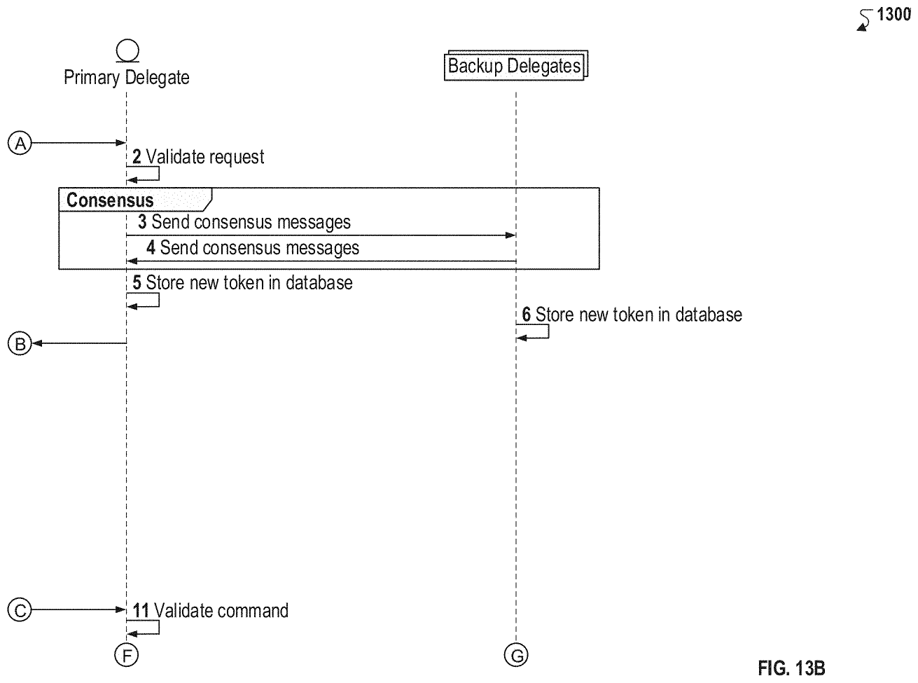

FIG. 12 is a sequence diagram that illustrates an example of a consensus sequence 1200 using a secondary waitlist. In this example, a transaction request received by a delegate that is not the designated primary for the request will be stored in that delegate's waiting list and a timer will be started. If the timer for this request expires before the request is post-committed by another delegate, the request will be promoted to the primary waiting list and proposed by the receiving delegate.

d. Epoch Transitions

As described throughout, time in the network 100 is divided into distinct, successive time periods (e.g., twelve hours) called “epochs.” Every epoch has a set of 32 delegates. During the period when the network 100 transitions from one epoch to the next one, eight oldest delegates will be replaced by eight new delegates. Every delegate serves four epochs and participates in five transition periods (e.g., if the delegate is not re-elected, also assuming no recall happened). A delegate is “new” in its first transition period, then is “persistent” in the following three transition periods, and finally is “retiring” in its last transition period before it goes offline. As discussed below, three types of transition periods can occur with epochs.

An epoch transition component can be responsible for all epoch transition related data structure, algorithms, and operations. Examples of such operations include:
Maintaining timers for proposing epoch transitions.
Switching to the new epoch number at the right time, so that there will not be any circular dependency among different kinds of blocks.
Creating an EpochManager component and all objects it contains every epoch, such as ConsensusManagers and ConsensusNetIOManager components. During an epoch transition period, a node could have two EpochManagers. Only one of them can propose pre-prepare messages.
Making TCP connections to peers, and disconnect from them when needed. In the current design, during the transition period, two persistent delegates will have two TCP connections between them. The protocol is able to distinguish a reconnection attempt from a new connection between the two peers.

The epoch transition component uses timers as well as network messages to trigger events of the epoch transitions. For example, an epoch transition period can have four timer events at −300 s, −30 s, 0 s, and +20 s related to epoch start. In this example, the first timer event represents a connection to a peer, the second timer event represents an epoch transition start, the third timer event represents an epoch start, and the fourth timer event represents an epoch transition end. Additionally, 20-second delays are introduced to accommodate processing delay, network delay, and clock drift.

When the first event is triggered, one of the boost thread pool thread will call the proper callback function to start make TCP connections to peer delegates of the coming epoch. The delegates have time to make the connections before the second timer event. At the second and third timer events (e.g., transition start and epoch start), delegates have different behavior depending on if they are new, persistent, or retiring. At the last event, delegates release unneeded resources and network connections.

There are also two network message triggered events that could happen before the third timer event (i.e., epoch start): (1) a post-commit message with the new epoch number is received and (2) a pre-prepare reject message with error code NEW_EPOCH is received. Most of the classes involved in the epoch transition process can have other responsibilities. For example, the purpose of a ConsensusManager's can be to handle consensus related tasks. As another example, the epoch transition component can interface with other components, as well as its main classes and sub-components.

When a delegate node starts, it creates a ConsensusContainer and starts the EventProposer (e.g., through “Archiver::Start” in the code). The EventProposer schedules a timer based epoch transition event. When the timer expires, a callback in the ConsensusContainer will handle the event and next transition event will be scheduled. Eventually, the delegate node retires and the EventProposer and ConsensusContainer become idle till the node is re-elected as a delegate again.

Every delegate participates in three types of epoch transitions, such as “new,” “persistent,” and “retiring.” In the “new” epoch transition, a delegate, being elected, changes its states. After start, an EpochManager is created with two timer-based events. The delegate then connects with its peer delegates in the same epoch and then starts working. In the “retiring” epoch transition, a retiring delegate eventually goes to a “Disconnect” state from a “Working” state at the end of its epochs. An important state transition to note is from “EpochWait” to “BackupDelegateOnly” while in a “working” state. In the “persistent” epoch transition, a persistent delegate in both the old epoch and new epoch does not stop working. During the epoch transition period, it has two “EpochManagers,” an “OldEpochManager” and a “NewEpochManager.” The “NewEpochManager” gradually takes over the responsibility of participating in the consensus sessions from the “OldEpochManager.”

The epoch transition processes involve multiple. Most of the classes have other responsibilities. For example, the “ConsensusContainer” class manages the epoch transition process. It contains an “EpochPeerManager,” which is a TCP server that accepts peer delegates' connection requests. The “ConsensusContainer” class also contains an EpochEventProposer that provides timer base events. The first timer will trigger the callback to “EpochTransitionEventsStart( )” in which a new “EpochManager” will be created, which will create a “ConsensusNetIOManager.” Once created, the “ConsensusNetIOManager” will make TCP connections to peer delegates. For example, two delegates determine the TCP client-server relationship between them basing on their “delegate_indices” defined in an “EpochBlock.” The one with lower index represents a server. The “EpochManager” will also create “ConsensusManagers” and other related objects. These objects provide two important network events, namely (1) new epochs in post-commit and (2) pre-prepare reject with error code “NEW_EPOCH,” to the “ConsensusContainer” through the “EpochManager.”

Client transactions are sent to the “ConsensusContainer” and processed by the current “EpochManager.” During the epoch transition period, a new “EpochManager” “transition_epoch” is created and swaps with the “current_epoch” at the right time. After the swap, when epoch transition period ends, the “transition_epoch” (which was the “current_epoch” before the swap) is destructed. In the code, when the two “EpochManagers” swap with each other, the new “current_epoch” also takes over the secondary waiting list by “SecondaryRequestHandler::UpdateRequestPromoter.”

A persistent delegate accepts TCP connection requests and eventually creates a “ConsensusConnection” object, which will be used by “ConsensusManagers” to send and receive network messages. As a persistent delegate, a “PeerAcceptor” is already started and accepting connection requests. It will accept connection requests to the new epoch and accepts re-connection requests to the old epoch. The two different kinds of requests can be distinguished by the first protocol message (“ConnectedClientIds”) sent through the underlining TCP connection once it is established. After that, the “OnConnectionAccepted( )” function of “ConsensusNetIOManager” is called to create a “ConsensusNetIO” object. The “ConsensusManagers” are notified to create a “ConsensusConnection” object, which binds to the newly created “ConsensusNetIO” object.

e. Epoch and Micro-Epoch Blocks

As described throughout, an epoch block is constructed at the end of every epoch (e.g., every 12 hours) to summarize the epoch. The epoch block includes voting results in the form of elected delegates, a summary of all transactions that were post-committed, and all the transaction fee collected in the epoch. In some implementations, intermediate epoch micro-blocks are used to simplify the process of constructing a large epoch block. The micro-blocks contain summaries of the transactions that occurred in a portion of the epoch. With micro-blocks, nodes would be able to periodically ensure they are fully synched at a much higher frequency than if they solely relied on the full epoch blocks.

Generally, both the micro-blocks and epoch blocks can be created by delegates periodically. They are approved by the delegate consensus before propagated to the network 100. The micro-block and epoch block components are responsible for handling all micro-blocks and epoch block operations. Examples of such operations include:
Building micro-blocks conforming to the IDD and initiate consensus sessions.
Verifying proposed micro-blocks as delegates, and verifying approved micro-blocks as non-delegate network nodes. The two-verification logic should be the same.
Maintaining the micro-block tip and the number of micro-blocks in an epoch.
Keeping the sum of transaction fees in an epoch.
Maintaining a list of delegate candidates and their stake and voting power.
Building epoch blocks conforming to the IDD and initiate consensus sessions.
Verifying proposed epoch blocks as delegates, and verifying approved epoch blocks as non-delegate network nodes. The two verification logic should be the same.
Storing valid micro-blocks and epoch blocks in the Database.
Maintaining timers for proposing micro-blocks and epoch blocks.

The micro-block and epoch block component uses timers to propose micro-blocks periodically. When a timer expires, one of the boost thread pool thread will call the proper callback function, which will build a micro-block with the information read from the local database, and initiate a consensus session. Similar to the batch state consensus, when backup delegates receive a pre-prepare message for a micro-block, they validate the block and reply with a prepare (and commit later) if the block is valid. When the last micro-block is approved by the delegates, the epoch block is proposed and a consensus session is initiated.

To reduce the unnecessary redundant micro-block and epoch block consensus sessions, the delegates agree on a default primary delegate of every micro-block or epoch block (for micro-blocks, it is computed based on the hash value of the previous block; for epoch blocks, it is the most voted delegate.). The default primary will propose first. Other delegates put the micro-block or the epoch block to their waiting lists with a timer. If the timer expires and the expected micro-block or the epoch block has not been post-committed, then the micro-block or the epoch block is proposed by the local node.

Micro-blocks and epoch blocks are created by delegates and must be approved by the delegate consensus. Hence, the micro-block and epoch block component have an Archiver class that creates micro-blocks and epoch blocks. After that, the Archiver uses a ConsensusContainer of the generic consensus framework to initiate consensus sessions. The specialized functionalities, such as the verification of a micro-block proposed by another delegate, are implemented by the specialized ConsensusManagers (such as a MicroBlockConsensusManager). In addition, the micro-block and epoch block component uses the database, and reads recall information from an IRecallHandler.

The creation of a micro-block is triggered periodically by an “EventPropose” component. Once triggered, the “MicroBlockConsensus” component is initiated, and a pre-prepare message is sent to all other delegates. Receiving this messages, other delegates will start “MicroBlockConsensus” sessions as backups. Then the regular consensus protocol will proceed. An epoch block can be crated using a similar consensus framework.

f. Token Specification

The system described throughout this document can be configured to utilize a token platform as an extension to supports the issuance, management and daily operations of tokens on top of its network architecture. Token operations can initiated by requests that are submitted to delegates and then approved using the consensus protocols described above.

Token accounts can be extensions of accounts associated with the network 100 in that they have a balance that can be increased or decreased by making transactions on the network 100. This results in a historical chain of operations. Additionally, token accounts contain settings that dictate which operations the token does or does not support. These settings also have mutability options that dictate whether or not the settings can be changed. For example, if the total supply for a particular token is set as immutable, then additional tokens cannot be issued. Furthermore, operations performed on a token account are chained together (e.g., in a manner similar as transactions between user accounts associated with the network 100) with each operation referring to the hash of the request that preceded it.

Token issuance refers to the process by which a new token is created. To create a new token, an issuer submits a token issuance request, including information that dictates the operation of the new token on the network 100. Once the request is confirmed, the token will be available for participants based on rules specified by the token's settings.

A token controller is an entity that has administrative privileges for modifying the settings governing a particular token. Token controllers can be appointed by the token issuer when a token is first created, or by a current controller once the token is already live. In order to modify a token account setting, a controller can submit (e.g., to a delegate) a request that expresses the desired change. Once this request is approved via a consensus protocol, the change will take effect on the network 100. The changes that a token controller can make to a token account are dictated by its set of privileges specified by a token issuer.

As discussed below, a token platform associated with the network 100 can leverage several databases for storing various information concerning tokens created on the platform. For example, a token account database can be used to store token accounts. Token accounts stored in this database contain their list of settings with current values, as well as the list of token controllers and their respective privileges.

As another example, a freeze list or whitelist database can be used to identify accounts that have been added to a freeze list (i.e., restricted from performing token transactions) or added to a whitelist (i.e., included in a list of accounts to be distributed token balances). The lists specified in this database can be implemented as partially distributed lists that untethered accounts will be stored in a centralized list. In contrast, tethered accounts do not need to be stored centrally, since the entries stored in these accounts can be used to demarcate the account's status. The centralized component for both lists will be implemented using a single database. The keys for this database are formed by hashing the token ID with the user's account address and the values for this database are bitfields that indicate this account's freeze and whitelist status for the corresponding token.

As another example, an account database can be used by the network 100 and leveraged by the token platform. This database can store token entries inside of user accounts. Each token entry contains that user's balance of tokens among other useful information.

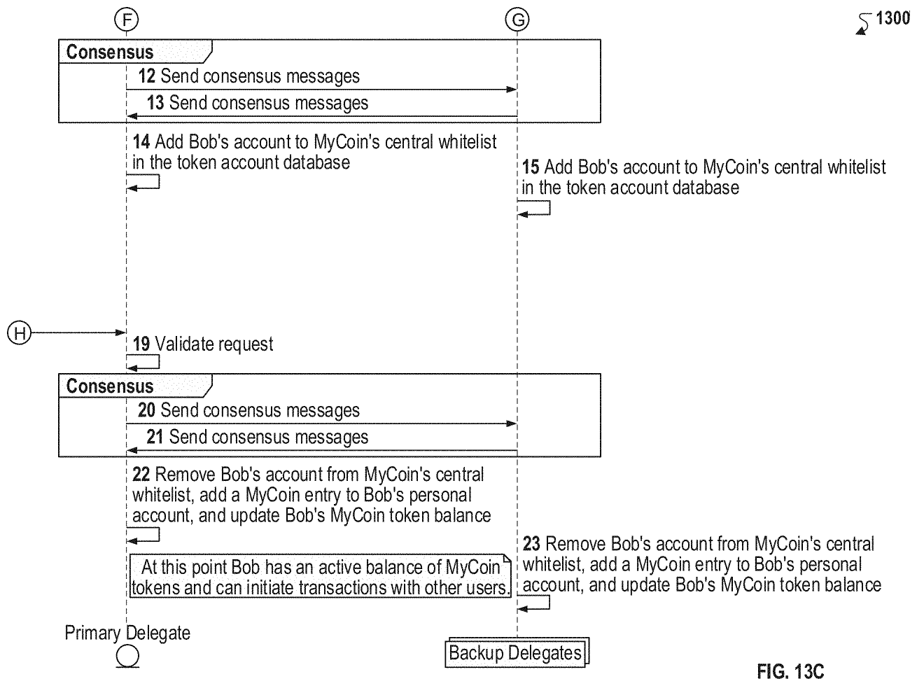

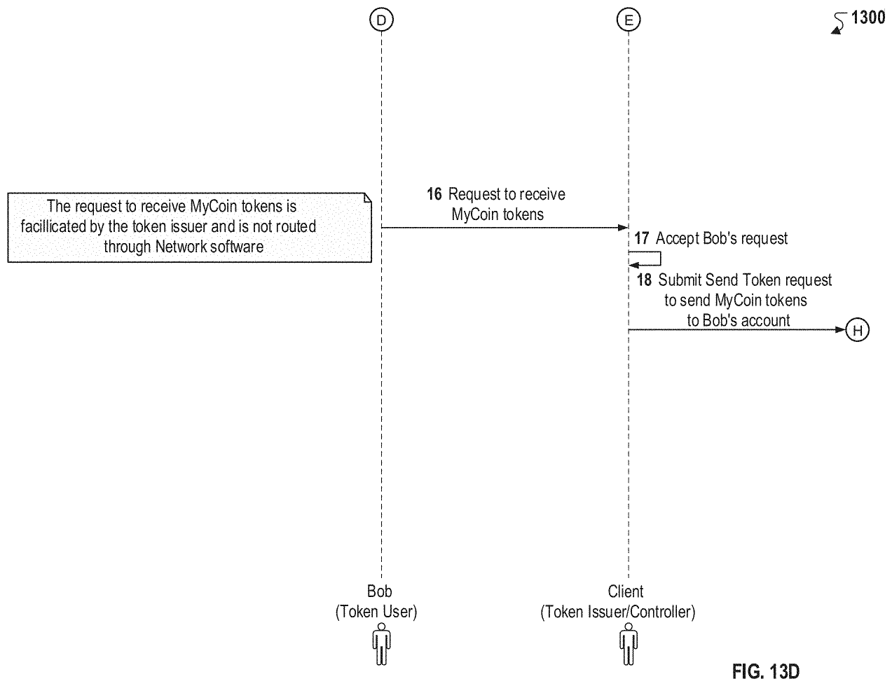

FIGS. 13A-D are sequence diagrams that illustrate an example of a token issuance process 1300. Referring initially to FIG. 13A, a client (or token issuer) initially submits a token request to issue a new token “MyCoin” for a token user “Bob.” Upon approval of the token request, a new token “MyCoin” will be created for use by the token user.

Referring now to FIG. 13B, a primary delegate receives the token request submitted by the token issuer and validates the token request using a consensus protocol discussed throughout this specification. For instance, the primary delegate exchanges consensus messages with backup delegates to confirm that the token issuer is authorized to issue tokens to be used with the network 100. Once validated, the primary delegate stores a new token “MyCoin” in an associated database. Data representing the newly issued token is also stored by the backup delegates in another database.

Referring back to FIG. 13A, the token issuer receives a reply from the primary delegate with a token identifier as a confirmation of the token request. The token identifier is associated with a new token account. The token identifier can be created by, for example, hashing the token issuer's previous hash (e.g., as identified in the token request), then hashing the token issuer's account address, and finally hashing the concatenation of the token symbol and name. In this way, the token identifier can be used to identify and/or associate the newly issued token, the token request, and the token issuer that submitted the token request.

Once the token is created, the token user applies to be whitelisted for the new created token. As described herein, whitelisting is initiated when a user submits a request to the appropriate entity. Tokens that use the whitelisting feature can require that before receiving any amount of the token, users are first ‘whitelisted’ by a token issuer, after which the user's account will able to receive and send tokens. To save space, rather than maintain a centralized list to store the address of every account that is whitelisted for a particular token, the system can leverage the token entry added to individual accounts to indicate the account's status. Additionally, tokens that do not use the whitelisting feature provide no barrier to entry, and any account can receive tokens at will.

The token request can be handled and/or managed by external third-party provider that operates independently of the network 100. For example, the network 100 can be associated by a first entity that manages, for example, consensus for transaction processing for associated accounts, and the token distribution platform can be associated with a second entity that whitelist token users that choose to use tokens in token accounts in association with transaction accounts of the network 100. In this example, the first and second entities can operate independently of one another, while token users are able to associate issued tokens with transactions performed using accounts of the network 100.

The token issuer validates the token user's application through the whitelisting process. For example, the token issuer can implement know-your-customer (KYC) or anti-money laundering (AML) procedures to ensure that the token user is not using the issued tokens to perform illicit transactions, such as money laundering, funding criminal enterprise activity, or other activity that satisfies regulatory reporting requirements for suspicious activity by a money transmitter. Once validated, the token issuer sends a command to the primary delegate to add the token user's account to the token whitelist. Referring back to FIG. 13B, the primary delegate validates the command received from the token issuer to add the token user's account to the token whitelist.

Referring now to FIG. 13C, the primary delegate uses the consensus protocol to validate the command received from the token issuer by exchanging consensus messages with the backup delegates. The primary delegate then adds a token account of the token user to a central whitelist of the new token within a token account database. The backup delegates also add data representing the token account to the central whitelist.

Referring now to FIG. 13D, after the token user has been added to the whitelist, the token issuer receives a request from the token user to receive tokens. The request processed by the token issuer without requiring access to software used to manage the network 100. As discussed above, the token issuer can be distinct and independent from an entity that manages the software used to operate the network 100. The token issuer accepts the token request and submits a send token request to the primary delegate.

Referring back to FIG. 13C, the primary delegate uses a consensus protocol to validate the send token request received from the token issuer. For instance, the primary delegate exchanges consensus messages with the backup delegates to validate the send token request from the token issuer. Once the send token request is validated, the primary delegate removes the token user's account from the central whitelist, adds a token entry to the token user's personal account, and updates the token user's token balance. The backup delegates then process similar adjustments by removing the token user's account from the central token whitelist, adding a token entry to the token user's personal account, and updating the token user's token balance. At this point, the token user has an active balance of tokens and can initiate transactions with other users using the active balance of tokens.

In some implementations, the system can employ a “freeze list” to prevent accounts from sending and/or receiving tokens. Freezing an account (i.e., by placing the account on the freeze list) prevents the account from sending and receiving tokens. A frozen account can be enforced based on token type. For example, if an account that has tokens for “MyCoin” and “YourCoin” gets frozen by a “MyCoin” token issuer, the account can be used to process transactions using “YourCoin” tokens. In this example, requests to send “MyCoin” tokens to or from frozen accounts will be rejected based on the presence of the account on the “MyCoin” freeze list.

In some instances, a freeze list can represent a central list that includes the address of each frozen account. However, this approach can result in database bloat if many accounts are frozen. Additionally, this approach may require nodes having to scan through many entries to confirm whether a particular account is or is not frozen, which limits transaction performance over the network 100.

The system can employ various techniques to address issues associated with a central list that includes the address of each frozen account. For example, the system can use a single bit in the token entry stored within an individual account to indicate whether this account is frozen. A token issuer may want to freeze accounts that have not yet been tethered to the token (e.g., an account is tethered by being whitelisted by a controller or by receiving tokens). To allow this, the system can enable a token issuer to add a token entry to an untethered account in order to set the appropriate bit. However, this technique can be exploited by a malicious controller who spams the network by freezing every account, permanently increasing the size of each account. To mitigate this, the system can maintain a central freeze list for untethered accounts. Since the users' accounts themselves will be used to implement the freeze list, the central freeze list does not need to be checked for transactions between accounts with preexisting token entries. The only time the central freeze list needs to be consulted is when an untethered account is about to receive tokens for the first time. When this occurs, the freeze list will be checked, and if the account in question is listed therein, the request will be rejected.

In some implementations, issuing a new token on the network 100 involves the token issuer to pay a fee (e.g., a fee higher than the minimum fee for native send transactions). The exact amount can be adjusted as a configuration parameter determined by the system and as with all other network fees. The sum of fees can be split among the delegates. Once a token has been issued, requests involving the token are subject to the network fee that is paid through network software. Requests to send tokens between users can also subject to an additional fee designated by the token issuer, which can be paid in tokens. For administrative requests submitted by the token issuers, network fees can be deducted from a transaction balance associated with the token account. For user requests, the account and token fees can be deducted from the source account's respective balances, and are respectively distributed amongst the delegates and deposited in an account determined by the token admins.

Each token created on the network 100 has a list of settings that describe the operations that can be performed on it. Values for token settings can be determined by the token issuer when the token is first created, and can be subsequently modified by token issuers with sufficient privileges. Examples of token settings are included in the table below:

| Setting | Description |
|---|---|
| Allow Additional Tokens | This determines whether the initial supply |
| | of tokens can ever be increased. |
| Allow Additional Tokens | * |
| Mutable | |
| Allow Revoke | This determines whether we can revoke |
| | tokens from user accounts. |
| Allow Revoke Mutable | * |
| Allow Freeze | This determines whether we can freeze |
| | user accounts. |
| Allow Freeze Mutable | * |
| Allow Adjust Fee | This determines whether we can change |
| | the transaction fee rate. |
| Allow Adjust Fee Mutable | * |
| Need Whitelist | This determines whether accounts need |
| | to be whitelisted before receiving tokens. |
| Need Whitelist Mutable | * |

* As indicated above, mutability setting descriptions are omitted as these settings just determine whether the corresponding setting can be modified. Once a setting is marked as immutable (i.e., the mutability setting is set to false), it cannot be changed. A request to modify a token account parameter can be allowed by the corresponding token account setting. Immutable settings cannot be changed.

### EXAMPLES

### A. Network Parameters

In one particular implementation, the network 100 uses the following parameters:
Token Supply: 100 billion tokens, divisible to 10 decimals (resulting in 10²⁴ indivisible units)
Epoch Length: 12 hours
Number of Representatives: 1,000 to 5,000
Number of Delegates: 50
Maximum Request Size: 2048 bytes
Deposit Size: on the order of $1
Minimum Transaction Fee: on the order of $0.00001
Proof of Work Difficulty: 10K hashes
Constituent Penalty (λ): 1/4

In this implementation, besides the token supply, which is a network invariant, all parameters are modifiable via the governance mechanism to allow the network 100 to adapt. All tokens can be minted in the genesis block to preserve invariants and subsequently will be distributed to users according to the initial distribution.

### B. Performance Analysis

To validate the network structure, network throughput and confirmation latency was estimated using the network parameters referenced above. It was assumed that delegates communicate through a binary tree and have an average one-directional latency of 100 ms.

The primary determinants of network throughput were validation time (that is, hardware) and node bandwidth. Table 2 shows throughput in transactions/second under ranges of both parameters for the unsharded network model. Under conservative expectations of 0.1 ms validation time and 100 Mbps, bandwidth is significantly more binding than hardware, limiting the network to about 2,500 tps. In reality, delegates are expected and, to a lesser extent, representatives to specialize as service providers with both above average hardware and network connectivity. This would allow the network to achieve capacity of 15,000-20,000 tps on the initial implementation. Sharding is expected improve this capacity by an order of magnitude to over 100,000 tps.

TABLE 2
Network throughput (tps) under various node bandwidth and verification
time assumptions. Gray indicates network is hardware-bound, while
white indicates network is bandwidth bound.

| | Validation time (ms) | | | | | |
|---|---|---|---|---|---|---|
| | 1 | 0.5 | 0.25 | 0.1 | 0.05 | 0.01 |
| 10 | 254 | 254 | 254 | 254 | 254 | 254 |
| 50 | 833 | 1,272 | 1,272 | 1,272 | 1,272 | 1,272 |
| 100 | 833 | 1,667 | 2,544 | 2,544 | 2,544 | 2,544 |
| 500 | 833 | 1,667 | 3,333 | 8,333 | 12,720 | 12,720 |
| 1000 | 833 | 1,667 | 3,333 | 8,333 | 16,667 | 25,441 |
| 10000 | 833 | 1,667 | 3,333 | 8,333 | 16,667 | 83,333 |

Average confirmation time under this model is 2.92 seconds, which is dominated by inter-delegate latency. Intelligent sharding can realistically reduce latency by a factor of 2 or more, resulting in an expected average confirmation time of around 1 second.

Processing a single transaction was estimated to have a marginal cost of less than $0.0008, which is dominated by IO costs. A dedicated server is expected reduce processing costs by an order of magnitude, and price should decline as hardware and bandwidth improve. However, even assuming all delegates run on a suitable cloud service, validators could be consistently profitable with just a $0:001 transaction fee while running, for example, a top line instance with 64+ cores, 200+ GB of RAM, SSD storage, and 10+ Gbps network speeds.

Storage requirements can be more difficult to estimate since they are heavily dependent on the number of accounts. The network 100 can be structured to encourage maximal pruning, which allows most nodes to only store balance and metadata associated with each active account. This amounts to, for example, less than 2 KB per account, or less than 200 GB for 100 million accounts.

In reality, the number of active accounts can often be orders of magnitude less than 100 million for several years at least, but the network 100 will be accessible to full nodes running commodity hardware even for an unexpectedly high number of accounts. Other data, such as current epoch requests and votes, will be considerably less in size, and can be discarded after they are finalized. Sharding will enable even further data pruning.

### C. Transaction Processing

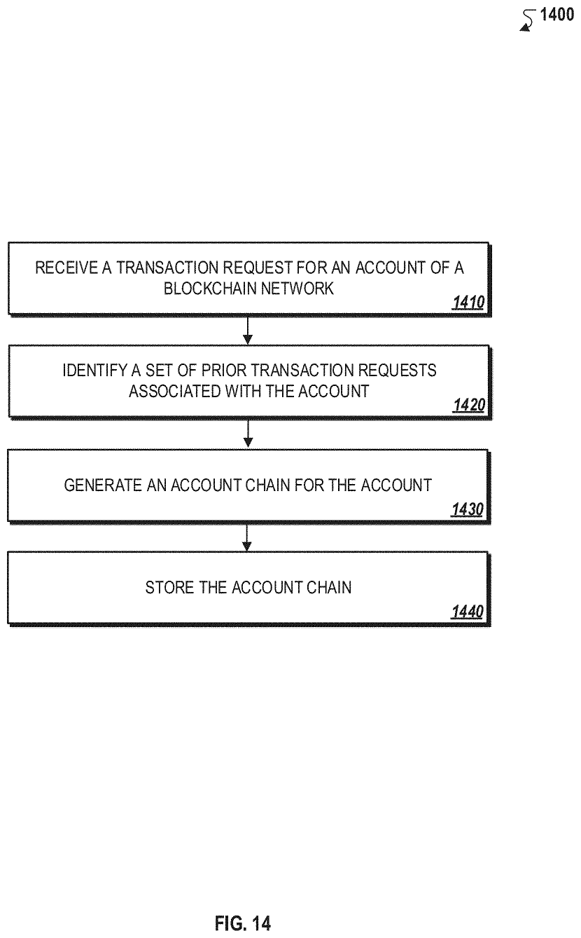

FIG. 14 is a flowchart that illustrates an example of a process 1400 for processing a blockchain-based transaction using a chain mesh network. Briefly, the process 1400 can include the operations of receiving a transaction request for an account of a blockchain network (1410), identifying a set of prior transaction requests associated with the account (1420), generating an account chain for the account (1430), and storing the account chain (1440).

In general, the process 1400 below in reference to a “system” that can include one or more computers implementing software for managing, operating, and/or maintaining the network 100. For example, in some implementations, the process 1400 is executed by a system that includes one or more dedicated servers that process send and/or receive transactions submitted over the chain mesh network 110. In other implementations, the process 1400 is executed by a system comprised of a decentralized network of computers that collective perform discrete operations relating to transaction processing over the network 100.

In more detail, the process 1400 can include the operation of receiving a transaction request for an account of a blockchain network (1410). For example, a system can receive a transaction request that includes at least a network identifier for an account associated with a blockchain network. As discussed above, the blockchain network can be a directed acyclic graph that is configured to store account chains for each account associated with the blockchain network. For instance, the blockchain network can be the network 100 depicted in FIG. 1. As discussed above, the network 100 represents a network of nodes that track a set of accounts, each with a balance of the native network token.

The process 1400 can include the operation of identifying a set of prior transaction requests associated with the account (1420). For example, the system can identify a set of prior transaction requests that were received by the system and are associated with the account. As discussed above, the prior transaction requests may have been received during a prior epoch that was assigned to a time period in which transaction requests were received by the system.

The process 1400 can include the operation of generating an account chain for the transaction request (1430). For example, the system generate an account chain incrementally with each received transaction request to avoid recalculating the entire account chain with each new transaction request. As discussed above, the account chain links data representing the set of prior transaction requests and data representing the transaction request. FIG. 1 illustrates examples of three account chains 102, 104, and 106 that are each associated with accounts “A,” “B,” and “C,” respectively. Transactions of each account are linked together in a corresponding account chain and are represented as “requests.” In the FIG. 1, request transactions are denoted as “R,” send transactions are denoted as “S,” and change representative requests are denoted as “C.” In some instances, generating the account chain involves verifying that the user has sufficient balance to cover a send transaction associated with the transaction request.

In some implementations, the archive node includes multiple epochs that are each assigned to a time period in which transaction requests are received by the system. In some instances, the time period assigned to each epoch can be very long (e.g., on the order of 12 hours), so limits imposed by the blockchain structure do not interfere with network speed. In such instances, rather than handling ongoing transactions (which can be done by the network 100), the archive node instead serves as a periodic checkpoint that summarizes what has changed in the system.

In some implementations, the operation 1430 of generating the account chain includes a set of additional operations. For instance, the operation 1430 can include identifying a timestamp associated with the transaction request. For example, the system can record the date and time in which the transaction request is received on the blockchain network. The operation 1430 can include determining that the timestamp falls within a particular time period assigned to a particular epoch from among the multiple epochs. For example, the system can determine that the timestamp of the transaction request indicates that it was received on the blockchain network during a particular hour that falls within a 12-hour period assigned to the particular epoch. The operation 1430 can also include assigning the data representing the transaction request to the particular epoch. For example, based on determining that that the timestamp of the transaction request indicates that it was received on the blockchain network during a particular hour that falls within a 12-hour period assigned to the particular epoch, data representing the transaction request (e.g., a transaction amount, an account to receive the transaction amount) can be assigned to the particular epoch.

The process 1400 can include the operation of storing the account chain (1440). For example, the system can store the account chain and the network identifier in an archive node of the network 100. As discussed above in reference to FIG. 2, the archive node can record all transactions that occurred in a set period of time in a blockchain. The archive node can also contain results of votes and other system events.

In some implementations, the archive node includes multiple blocks that each include a block that corresponds to one of the multiple epochs. For example, as discussed above, in some instances, the archive node can be generated to represent data assigned to multiple epochs (e.g., data received in a 60-hour time period that is assigned to five distinct epochs of 12-hour time intervals).

In some implementations, the operation 1440 of storing the account chain and the network identifier within the archive node of the blockchain network includes additional operations. For instance, the operation 1440 can include assigning a respective epoch to each transaction request included in the account chain. For example, the system can assign an epoch from multiple epochs of the archive node to each transaction request based on the timestamp information of the transaction request. The operation 1440 can also include storing data representing corresponding transaction requests assigned to a particular epoch in a corresponding block from among the multiple blocks. For example, the system can organize the archive node so that epoch assignment is referenced within the archive record.

In some implementations, each of the multiple blocks provides a checkpoint that causes the system to execute state synchronization across nodes of the blockchain network. For example, as discussed above, because the network 100 does not use an unspent transaction output (UTXO) structure, each account chain can be extensively pruned due to the existence of the balance field and a periodic checkpoint mechanism.

In some implementations, the process 1400 additionally includes the operation of performing consensus, as described throughout this document. In such implementations, the system initially verifies that the transaction request represents a valid transaction (e.g. an account has sufficient balance for a send transaction). The system then includes the transaction request in a batch of other transactions and runs consensus using, for example, the consensus protocol discussed above in reference to FIG. 9. Upon the completion of consensus, the system updates databases to reflect that the transaction has been finalized. On the end of an epoch, the system reflects the cumulative set of transactions that have occurred during that epoch.

### D. Computer System

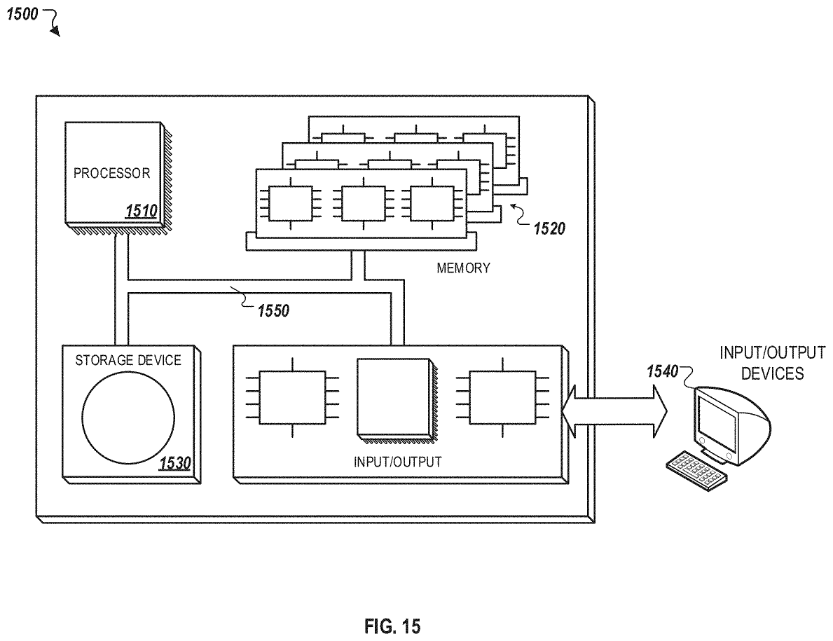

FIG. 15 is a schematic diagram of a computer system 1500. The system 1500 can be used to carry out the operations described in association with any of the computer-implemented methods described previously, according to some implementations. In some implementations, computing systems and devices and the functional operations described in this specification can be implemented in digital electronic circuitry, in tangibly-embodied computer software or firmware, in computer hardware, including the structures disclosed in this specification (e.g., system 1500) and their structural equivalents, or in combinations of one or more of them. The system 1500 is intended to include various forms of digital computers, such as laptops, desktops, workstations, personal digital assistants, servers, blade servers, mainframes, and other appropriate computers, including vehicles installed on base units or pod units of modular vehicles. The system 1500 can also include mobile devices, such as personal digital assistants, cellular telephones, smartphones, and other similar computing devices. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The system 1500 includes a processor 1510, a memory 1520, a storage device 1530, and an input/output device 1540. Each of the components 1510, 1520, 1530, and 1540 are interconnected using a system bus 1540. The processor 1510 is capable of processing instructions for execution within the system 1500. The processor may be designed using any of a number of architectures. For example, the processor 1510 may be a CISC (Complex Instruction Set Computers) processor, a RISC (Reduced Instruction Set Computer) processor, or a MISC (Minimal Instruction Set Computer) processor.

In one implementation, the processor 1510 is a single-threaded processor. In another implementation, the processor 1510 is a multi-threaded processor. The processor 1510 is capable of processing instructions stored in the memory 1520 or on the storage device 1530 to display graphical information for a user interface on the input/output device 1540.

The memory 1520 stores information within the system 1500. In one implementation, the memory 1520 is a computer-readable medium. In one implementation, the memory 1520 is a volatile memory unit. In another implementation, the memory 1520 is a non-volatile memory unit.

The storage device 1530 is capable of providing mass storage for the system 1500. In one implementation, the storage device 1530 is a computer-readable medium. In various different implementations, the storage device 1530 may be a floppy disk device, a hard disk device, an optical disk device, or a tape device.

The input/output device 1540 provides input/output operations for the system 1500. In one implementation, the input/output device 1540 includes a keyboard and/or pointing device. In another implementation, the input/output device 1540 includes a display unit for displaying graphical user interfaces.

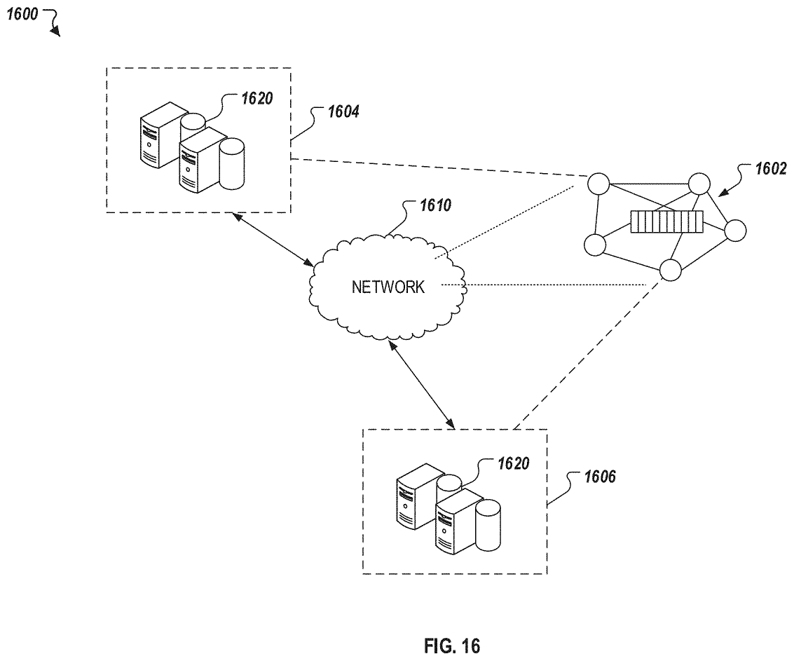

FIG. 16 is a schematic diagram that illustrates an example of an environment 1600 can be used to execute implementations of the present specification. In some examples, the example environment 1600 enables entities to participate in a blockchain network 1602 (e.g., the chain mesh network 100 depicted in FIG. 1). The environment 1600 includes computing systems 1604, 1606, and a network 1610. In some examples, the network 1610 includes a local area network (LAN), wide area network (WAN), the Internet, or a combination thereof, and connects web sites, user devices (e.g., computing devices), and back-end systems. In some examples, the network 1610 can be accessed over a wired and/or a wireless communications link. In some cases, the nodes of the blockchain network 1602 (e.g., 1604, 1606) communicate using the network 1610.

In the depicted example, the computing systems 1604, 1606 can each include any appropriate computing system that enables participation as a node in the blockchain network 1602. Examples of computing devices include, without limitation, a server, a desktop computer, a laptop computer, a tablet computing device, and a smartphone. In some examples, the computing systems 1604, 1606 host one or more computer-implemented services for interacting with the blockchain network 1602. For example, the computing system 1604 can host computer-implemented services of a first entity (e.g., an entity that manages the network 100), such as a transaction management system that the first entity uses to manage its transactions with one or more other entities. The computing system 1606 can host computer-implemented services of a second entity (e.g., a token issuer that issues tokens to be used in transactions processed over the network 100), such as a transaction management system that the second entity uses to manage its transactions with one or more other entities (e.g., other users). In the example of FIG. 16, the blockchain network 1602 is represented as a peer-to-peer network of nodes, and the computing systems 1604, 1606 provide nodes of the first entity, and second entity respectively, which participate in the blockchain network 1602.

Various implementations of the systems and methods described here can be realized in digital electronic circuitry, integrated circuitry, specially designed ASICs (application specific integrated circuits), computer hardware, firmware, software, and/or combinations of such implementations. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device, e.g., magnetic discs, optical disks, memory, Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device, e.g., a CRT (cathode ray tube) or LCD (liquid crystal display) monitor for displaying information to the user and a keyboard and a pointing device, e.g., a mouse or a trackball by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The systems and techniques described here can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the systems and techniques described here, or any combination of such back end, middleware, or front end components. The components of the system can be interconnected by any form or medium of digital data communication, e.g., a communication network. Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It should be understood that processor as used herein means one or more processing units (e.g., in a multi-core configuration). The term processing unit, as used herein, refers to microprocessors, microcontrollers, reduced instruction set circuits (RISC), application specific integrated circuits (ASIC), logic circuits, and any other circuit or device capable of executing instructions to perform functions described herein.

It should be understood that references to memory mean one or more devices operable to enable information such as processor-executable instructions and/or other data to be stored and/or retrieved. Memory may include one or more computer readable media, such as, without limitation, hard disk storage, optical drive/disk storage, removable disk storage, flash memory, non-volatile memory, ROM, EEPROM, random access memory (RAM), and the like.

Additionally, it should be understood that communicatively coupled components may be in communication through being integrated on the same printed circuit board (PCB), in communication through a bus, through shared memory, through a wired or wireless data communication network, and/or other means of data communication. Additionally, it should be understood that data communication networks referred to herein may be implemented using Transport Control Protocol/Internet Protocol (TCP/IP), User Datagram Protocol (UDP), or the like, and the underlying connections may comprise wired connections and corresponding protocols, for example, Institute of Electrical and Electronics Engineers (IEEE) 802.3 and/or wireless connections and associated protocols, for example, an IEEE 802.11 protocol, an IEEE 802.15 protocol, and/or an IEEE 802.16 protocol.

A technical effect of systems and methods described herein includes at least one of: (a) increased accuracy in facial matching systems; (b) reduction of false accept rate (FAR) in facial matching; (c) increased speed of facial matching.

Although specific features of various implementations of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object oriented databases, and any other structured collection of records or data that is stored in a computer system. The above examples are example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In some implementations, a computer program is provided, and the program is embodied on a computer readable medium. In an example implementation, the system is executed on a single computer system, without requiring a connection to a sever computer. In a further implementation, the system is being run in a Windows® environment (Windows is a registered trademark of Microsoft Corporation, Redmond, Wash.). In yet another implementation, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some implementations, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “example implementation” or “some implementations” of the present disclosure are not intended to be interpreted as excluding the existence of additional implementations that also incorporate the recited features.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

A number of implementations have been described. Nevertheless, it will be understood that various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations have been described. Nevertheless, it will be understood that various modifications may be made without departing from the spirit and scope of the invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

It should be understood that processor as used herein means one or more processing units (e.g., in a multi-core configuration). The term processing unit, as used herein, refers to microprocessors, microcontrollers, reduced instruction set circuits (RISC), application specific integrated circuits (ASIC), logic circuits, and any other circuit or device capable of executing instructions to perform functions described herein.

It should be understood that references to memory mean one or more devices operable to enable information such as processor-executable instructions and/or other data to be stored and/or retrieved. Memory may include one or more computer readable media, such as, without limitation, hard disk storage, optical drive/disk storage, removable disk storage, flash memory, non-volatile memory, ROM, EEPROM, random access memory (RAM), and the like.

Additionally, it should be understood that communicatively coupled components may be in communication through being integrated on the same printed circuit board (PCB), in communication through a bus, through shared memory, through a wired or wireless data communication network, and/or other means of data communication. Additionally, it should be understood that data communication networks referred to herein may be implemented using Transport Control Protocol/Internet Protocol (TCP/IP), User Datagram Protocol (UDP), or the like, and the underlying connections may comprise wired connections and corresponding protocols, for example, Institute of Electrical and Electronics Engineers (IEEE) 802.3 and/or wireless connections and associated protocols, for example, an IEEE 802.11 protocol, an IEEE 802.15 protocol, and/or an IEEE 802.16 protocol.

A technical effect of systems and methods described herein includes at least one of: (a) increased accuracy in facial matching systems; (b) reduction of false accept rate (FAR) in facial matching; (c) increased speed of facial matching.

Although specific features of various implementations of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method for processing a blockchain-based transaction, the method comprising:
receiving, by one or more computers, a transaction request that includes at least a network identifier for an account associated with a blockchain network;
identifying, by the one or more computers, a set of prior transaction requests that (i) were received by the one or more computers, and (ii) are associated with the account;
generating, by the one or more computers, an account chain for the transaction request, wherein the account chain links (i) data representing the set of prior transaction requests and (ii) data representing the transaction request; and
storing, by the one or more computers, the account chain and the network identifier.

2. The method of claim 1, wherein storing the account chain and the network identifier comprises storing the account chain and the network identifier within an archive node of the blockchain network.

3. The method of claim 1, wherein the blockchain network is a directed acyclic graph that is configured to store account chains for each account associated with the blockchain network.

4. The method of claim 2, wherein the archive node comprises multiple epochs that are each assigned to a time period in which transaction requests are received by the one or more computers.

5. The method of claim 4, wherein the time period is twelve hours.

6. The method of claim 4, wherein generating the account chain for the account comprises:
identifying a timestamp associated with the transaction request;
determining that the timestamp falls within a particular time period assigned to a particular epoch from among the multiple epochs; and
assigning the data representing the transaction request to the particular epoch.

7. The method of claim 4, wherein the archive node comprises multiple blocks that each correspond to one of the multiple epochs.

8. The method of claim 7, wherein storing the account chain and the network identifier within the archive node of the blockchain network comprises:
assigning a respective epoch to each transaction request included in the account chain; and
storing data representing corresponding transaction requests assigned to a particular epoch in a corresponding block from among the multiple blocks.

9. The method of claim 7, wherein each of the multiple blocks provides a checkpoint that causes the one or more computers to execute state synchronization across nodes of the blockchain network.

10. A system comprising:
one or more computers; and
one or more storage devices storing instructions that, when executed by the one or more computers, cause the one or more computers to perform operations comprising:
receiving, by the one or more computers, a transaction request that includes at least a network identifier for an account associated with a blockchain network;
identifying, by the one or more computers, a set of prior transaction requests that (i) were received by the one or more computers, and (ii) are associated with the account;
generating, by the one or more computers, an account chain for the transaction request, wherein the account chain links (i) data representing the set of prior transaction requests and (ii) data representing the transaction request; and
storing, by the one or more computers, the account chain and the network identifier.

11. The system of claim 10, wherein storing the account chain and the network identifier comprises storing the account chain and the network identifier within an archive node of the blockchain network.

12. The system of claim 10, wherein the blockchain network is a directed acyclic graph that is configured to store account chains for each account associated with the blockchain network.

13. The system of claim 11, wherein the archive node comprises multiple epochs that are each assigned to a time period in which transaction requests are received by the one or more computers.

14. The system of claim 13, wherein the time period is twelve hours.

15. The system of claim 13, wherein generating the account chain for the account comprises:
identifying a timestamp associated with the transaction request;
determining that the timestamp falls within a particular time period assigned to a particular epoch from among the multiple epochs; and
assigning the data representing the transaction request to the particular epoch.

16. A non-transitory computer-readable storage device encoded with computer program instructions that, when executed by one or more computers, cause the one or more computers to perform operations comprising:
receiving, by the one or more computers, a transaction request that includes at least a network identifier for an account associated with a blockchain network;
identifying, by the one or more computers, a set of prior transaction requests that (i) were received by the one or more computers, and (ii) are associated with the account;
generating, by the one or more computers, an account chain for the transaction request, wherein the account chain links (i) data representing the set of prior transaction requests and (ii) data representing the transaction request; and
storing, by the one or more computers, the account chain and the network identifier.

17. The non-transitory computer-readable storage device of claim 16, wherein storing the account chain and the network identifier comprises storing the account chain and the network identifier within an archive node of the blockchain network.

18. The non-transitory computer-readable storage device of claim 16, wherein the blockchain network is a directed acyclic graph that is configured to store account chains for each account associated with the blockchain network.

19. The non-transitory computer-readable storage device of claim 17, wherein the archive node comprises multiple epochs that are each assigned to a time period in which transaction requests are received by the one or more computers.

20. The non-transitory computer-readable storage device of claim 19, wherein the time period is twelve hours.
